(19) United States
(12) Patent Application Publication
(10) Pub. No.: US 2025/0214042 A1
(43) Pub. Date: Jul. 3, 2025

(54) MEMBRANES INCORPORATED WITH POROUS POLYMER FRAMEWORKS

(71) Applicant: The Regents of the University of California, Oakland, CA (US)

(72) Inventors: Jeffrey R. Long, Lafayette, CA (US); Adam Andrew Uliana, Oakland, CA (US); Ever Onery Velasquez, El Cerrito, CA (US)

(21) Appl. No.: 18/852,444

(22) PCT Filed: Mar. 31, 2023
(86) PCT No.: PCT/US2023/017202

§ 371 Date: Sep. 28, 2024

Related U.S. Application Data
(60) Provisional application No. 63/326,255, filed on Mar. 31, 2022.

(51) Int. Cl. B01D 71/06; B01D 67/00; B01D 69/02; B01D 69/14

(52) U.S. Cl. CPC B01D 71/06; B01D 67/0009; B01D 69/02; B01D 69/141; B01D 2257/108; B01D 2257/11; B01D 2258/018

(57) ABSTRACT

The disclosure relates to composite membranes for selective separation and processing of fluids and industrial applications.

### CROSS REFERENCE TO RELATED APPLICATIONS

This application claims priority under 35 U.S.C. § 119 from U.S. Provisional Application Ser. No. 63/326,255 filed Mar. 31, 2022, the disclosures of each of which are incorporated herein by reference in their entirety.

### STATEMENT REGARDING FEDERALLY SPONSORED RESEARCH

This invention was made with Government support under DE-SC0001015 awarded by the U.S. Department of Energy. The government has certain rights in the invention.

### TECHNICAL FIELD

The disclosure relates to membranes and membranes systems for the separation of trace components in a fluid mixture. The disclosure provides for composite membranes that are comprised of a polymer/membrane matrix which contains or is embedded with porous aromatic frameworks, and uses thereof.

### BACKGROUND

Membrane-based gas separation technology has potential for being an energy-efficient alternative relative to thermal or adsorption separation processes such as distillation, which incurs a huge energy penalty due to phase changes. The advantages of membranes include their lower operating and capital costs and continuous operations. However, membranes are generally limited in implementation due to the well-known selectivity-permeability tradeoff. Transport of gases in glassy polymers is governed through the solution-diffusion mechanism, with selectivity generally being determined by the differences in diffusion of permeating species. The diffusivities of species in polymers can be dramatically altered synthetically by disrupting polymer chain packing through the addition of bulky side groups or stiff backbones, and this approach has led to the creation of hundreds of new polymers. While this approach has led to highly permeable membranes due to increases in statistical free volume, the phenomena of aging is observed in these materials, where permeability is dramatically reduced over time due to polymer chain dynamics that decrease the non-equilibrium free volume. These polymers usually still suffer from the selectivity-permeability tradeoff as well.

Mixed-matrix composite membranes with nanoparticle fillers dispersed in a polymer matrix have been shown to surpass separation performances limited by the selectivity-permeability tradeoff in traditional polymeric membranes. These composite membranes have also been shown to improve chemical and mechanical stability. Various fillers have been studied for these applications, such as carbon molecular sieves, metal-organic frameworks, and zeolites, where these fillers improve separation through size-sieving or adsorption solubility enhancements. These increases in performance show the potential of this mixed-matrix approach, but in most studies, decreases in performances are usually observed due to filler/polymer incompatibility or changes in nanoparticle dispersion during membrane fabrication. Furthermore, most studies utilize a filler that can preferentially interact with only one specific species, whereas a filler that can be generalizable for many various separations would be potentially more impactful.

### SUMMARY

The disclosure provides a generalizable approach to tune the diffusivity and solubility components of membranes for enhanced performance. The disclosure describes incorporated porous aromatic framework (PAF) fillers into various membrane matrices and have shown increased permeation rates with minimal to no decreases in selectivity. These improvements were shown to be due to the ultrahigh porosity, strong chemical compatibility, and unique physicochemical properties of the PAF fillers. Membrane permeability increases as high as 520% with maintained selectivities were observed upon PAF incorporation for various industrially relevant gas mixtures (CO₂/CH₄, CO₂/N₂, H₂/N₂, H₂/CH₄, He/N₂, He/CH₄, O₂/N₂, and C₂H₄/C₂H₆). Further functionalization of these PAF fillers were also shown to increase permeation rates while also increasing chemical stability of the membrane structure, enabling plasticization resistance at high pressures of CO2. The coupling of increased permeation and chemical stability uniquely addresses multiple material limitations that are required for commercial implementation of membranes.

The disclosure provides a composite membrane comprising a polymer/membrane matrix that contains or is embedded with one or more types of porous aromatic frameworks (PAFs), porous organic frameworks (POFs) and/or porous polymer networks (PPNs), wherein the one or more types of PAFs, optionally comprising functional groups, bind with a high specificity to a targeted ion, organic molecule, or contaminant, wherein the one or more types of PAFs comprise a series of nodes linked together by linking ligands, wherein the series of nodes have a formula of Formula Ia:

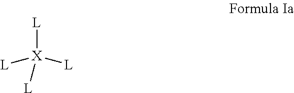

wherein, X is selected from C, B⁻ and P⁺; or wherein the series of nodes have a formula of Formula Ib:

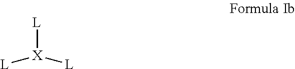

wherein, X is selected from N, Si, Ge, a benzene and Al, and L is a linking ligand; and wherein the linking ligand has a structure of Formula II or III:

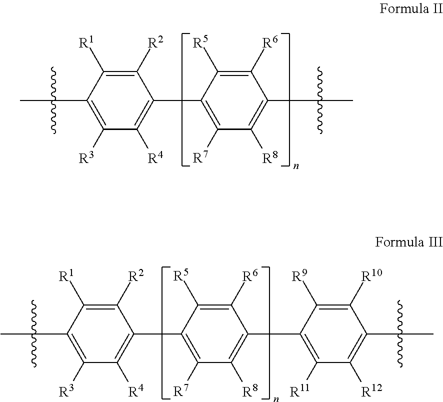

wherein, R¹-R¹² are independently selected from H, C₁₋₅ alkane or a polyamine; and n is an integer selected from 0, 1, 2, 3, 4, or 5; and wherein the composite membrane maintains selectivity to a targeted organic molecule, contaminant, or other gas in the presence of other competing molecules when compared to the pure polymer membrane material absent the one or more PAFs, POFs and/or PPNs. In one embodiment, the PAF, has the general structure:

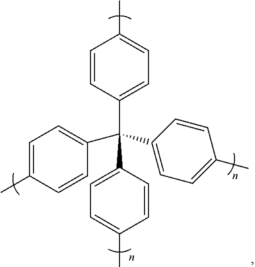

wherein n is any integer between 2 and 500. In another embodiment, the PAF, POF and/or PPN, has the general structure:

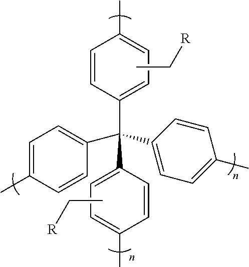

wherein R is a C₁₋₅ alkane or a polyamine; wherein n is any integer between 2 and 500. In a further embodiment, R is —CH₃. In still another or further embodiment, R is selected from the group consisting of

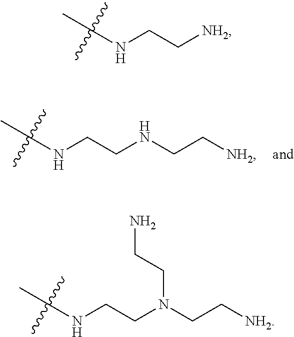 [SMILES: *NCCN ; *NCCNCCN ; *NCCN(CCN)CCN]

In still another or further embodiment of any of the foregoing embodiments, the polymer/membrane matrix is selected from the group consisting of polyolefins; polystyrene; silicones; polyacetylenes; polysulfones; polysulfonamides; polyacetals; polyethers; polyethylenimines; polycarbonates; cellulosic polymers; polyamides; polyimides; polyetherimides; polyamide imides; polyketones; polyether ketones; polyarylene oxides; polyurethanes; polyureas; polyazomethines; polyesters; polysulfides; heterocyclic thermoplastics; polycarbodiimides; polyphosphazines; polyhydrazides; and copolymers thereof, including block copolymers, grafts, and blends thereof. In a further embodiment, the polymer/membrane matrix is selected from the group consisting of cellulose acetate, polysulfones, perfluoropolymers, polyphenylene oxide, polyamides, polyimides, aryl polyetherimides, polyetherimides, Ultem 1000, (4,4′-hexafluoroisopropylidene)diphthalic anhydride (6FDA)-based polyimides, 6FDA-DAM, 6FDA-DAT, 6FDA-Durene, 6FDA-DAT:DAT, and Matrimid 5218. In another embodiment, the PAFs, POFs, and/or PPNs are present at a density of about 0.315-0.345 g/mL. In another embodiment, the PAFs, POFs, and/or PPNs are present at about 5-40 wt % of the composite membrane. In still another embodiment, the PAFs, POFs, and/or PPNs are present at about 10-55 vol % in the polymer/membrane matrix. In yet another embodiment, the composite has a glass transition temperature of about 390-395° C. in a membrane matrix of 6FDA-DAM. In another embodiment, the PAFs, POFs and/or PPNs comprise a substantially uniform pore size. In yet another embodiment, the PAFs, POFs and/or PPNs are substantially evenly distributed in the polymer/membrane matrix. In still another embodiment, the PAFs, POFs and/or PPNs comprise a particle size of 50-300 nm. In another embodiment, the PAFs, POFs and/or PPNs form (i) a π-π stacking between aromatic groups on the PAFs, POFs and/or PPNs and polymer/membrane matrix aromatic groups; and/or (ii) hydrogen bonds between amines or oxygen-rich groups appended onto PAFs, POFs, and/or PPNs and polar moieties on polymer/membrane matrix groups. In a further embodiment, (i) and/or (ii) improve the mechanical stability of the composite membrane. In still further embodiments, the presence of the PAFs, POFs, and/or PPNs in the polymer/membrane matrix improves the mechanical property of the membrane compared to membranes lacking the PAFs, POFs, and/or PPNs. In a further embodiment, the improved mechanical and/or chemical property reduces or eliminates membrane swelling and/or improves plasticization resistance. In another embodiment, the composite membrane has increased permeability of a targeted molecule relative to a permeability afforded by the polymer/membrane matrix lacking PAFs, POFs and/or PPNs. In yet another embodiment, the composite comprises increased permeation rates compared to polymer/membrane composites lacking PAFs, POFs and/or PPNs with minimal to no decreases in selectivity.

The disclosure also provides a method of making a composite of the disclosure, the method comprising (a) adding about 30% of the polymer/membrane matrix to a solution of dispersed PAFs, POFs and/or PPNs particles and allowing the polymer/membrane matrix material to coat the PAFs, POFs and/or PPNs; and (b) adding the remaining polymer/membrane matrix material to (a).

The disclosure also provides a method for removing a targeted contaminant from a fluid feedstock, the method comprising contacting a fluid feedstock with a composite membrane of the disclosure, wherein the fluid feedstock comprises the targeted contaminant, wherein the targeted contaminant is absorbed, captured or selectively allowed to pass through the membrane by the PAFs, POFs and/or PPNs present in the composite membrane. In one embodiment, the fluid feedstock comprises a targeted contaminant selected from carbon dioxide, hydrogen sulfide, nitrogen, water, sulfur oxide, nitrogen oxide, olefin, paraffin, helium, hydrogen, oxygen and methane. In another embodiment, the method separates or isolates carbon dioxide. In a further embodiment, the method is used in coal flue gas, oxy-fuel combustion, air, biogas, and natural gas. In another embodiment, the method separates H₂ in syngas, ammonia synthesis purge gas, and refinery fuel gas streams. In another embodiment, the method is used to separate helium in natural gas and off gas from nitrogen rejection units used in natural gas processing. In another embodiment, the method is used for recovery of oxygen found in ambient air. In still another embodiment of any of the foregoing embodiments, the composite comprises a polymer/membrane matrix that contains or is embedded with one or more types of porous aromatic frameworks (PAFs), porous organic frameworks (POFs) and/or porous polymer networks (PPNs), wherein the one or more types of PAFs, optionally comprising functional groups, bind with a high specificity to a targeted ion, organic molecule, or contaminant, wherein the one or more types of PAFs comprise a series of nodes linked together by linking ligands, wherein the series of nodes have a formula of Formula Ia:

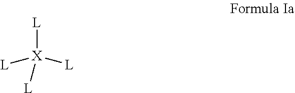

wherein, X is selected from C, B⁻ and P⁺; or wherein the series of nodes have a formula of Formula Ib:

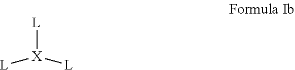

wherein, X is selected from N, Si, Ge, a benzene and Al, and L is a linking ligand; and wherein the linking ligand has a structure of Formula II or III:

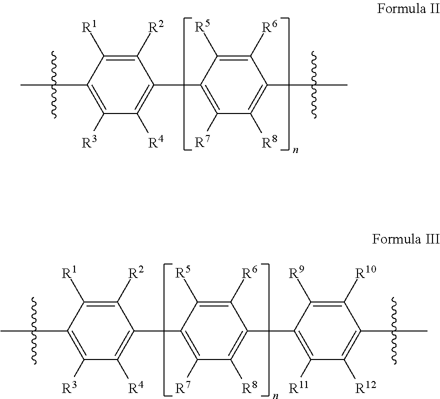

wherein, R¹-R¹² are independently selected from H, C₁₋₅ alkane or a polyamine; and n is an integer selected from 0, 1, 2, 3, 4, or 5; and wherein the composite membrane maintains selectivity to a targeted organic molecule, contaminant, or other gas in the presence of other competing molecules when compared to the pure polymer membrane material absent the one or more PAFs, POFs and/or PPNs. In one embodiment, the PAF, has the general structure:

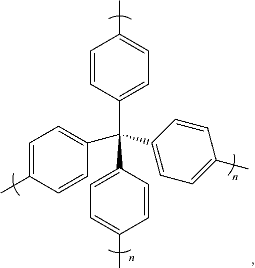

wherein n is any integer between 2 and 500. In another embodiment, the PAF, POF and/or PPN, has the general structure:

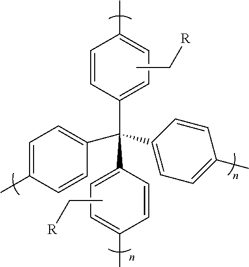

wherein R is a C₁₋₅ alkane or a polyamine; wherein n is any integer between 2 and 500. In a further embodiment, R is —CH₃. In still another or further embodiment, R is selected from the group

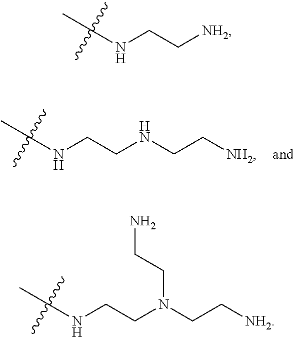 [SMILES: *NCCN ; *NCCNCCN ; *NCCN(CCN)CCN]

In still another or further embodiment of any of the foregoing embodiments, the polymer/membrane matrix is selected from the group consisting of polyolefins; polystyrene; silicones; polyacetylenes; polysulfones; polysulfonamides; polyacetals; polyethers; polyethylenimines; polycarbonates; cellulosic polymers; polyamides; polyimides; polyetherimides; polyamide imides; polyketones; polyether ketones; polyarylene oxides; polyurethanes; polyureas; polyazomethines; polyesters; polysulfides; heterocyclic thermoplastics; polycarbodiimides; polyphosphazines; polyhydrazides; and copolymers thereof, including block copolymers, grafts, and blends thereof. In a further embodiment, the polymer/membrane matrix is selected from the group consisting of cellulose acetate, polysulfones, perfluoropolymers, polyphenylene oxide, polyamides, polyimides, aryl polyetherimides, polyetherimides, Ultem 1000, (4,4′-hexafluoroisopropylidene)diphthalic anhydride (6FDA)-based polyimides, 6FDA-DAM, 6FDA-DAT, 6FDA-Durene, 6FDA-DAT:DAT, and Matrimid 5218. In another embodiment, the PAFs, POFs, and/or PPNs are present at a density of about 0.315-0.345 g/mL. In another embodiment, the PAFs, POFs, and/or PPNs are present at about 5-40 wt % of the composite membrane. In still another embodiment, the PAFs, POFs, and/or PPNs are present at about 10-55 vol % in the polymer/membrane matrix. In yet another embodiment, the composite has a glass transition temperature of about 390-395° C. in a membrane matrix of 6FDA-DAM. In another embodiment, the PAFs, POFs and/or PPNs comprise a substantially uniform pore size. In yet another embodiment, the PAFs, POFs and/or PPNs are substantially evenly distributed in the polymer/membrane matrix. In still another embodiment, the PAFs, POFs and/or PPNs comprise a particle size of 50-300 nm. In another embodiment, the PAFs, POFs and/or PPNs form (i) a π-π stacking between aromatic groups on the PAFs, POFs and/or PPNs and polymer/membrane matrix aromatic groups; and/or (ii) hydrogen bonds between amines or oxygen-rich groups appended onto PAFs, POFs, and/or PPNs and polar moieties on polymer/membrane matrix groups. In a further embodiment, (i) and/or (ii) improve the mechanical stability of the composite membrane. In still further embodiments, the presence of the PAFs, POFs, and/or PPNs in the polymer/membrane matrix improves the mechanical property of the membrane compared to membranes lacking the PAFs, POFs, and/or PPNs. In a further embodiment, the improved mechanical and/or chemical property reduces or eliminates membrane swelling and/or improves plasticization resistance. In another embodiment, the composite membrane has increased permeability of a targeted molecule relative to a permeability afforded by the polymer/membrane matrix lacking PAFs, POFs and/or PPNs. In yet another embodiment, the composite comprises increased permeation rates compared to polymer/membrane composites lacking PAFs, POFs and/or PPNs with minimal to no decreases in selectivity.

### DESCRIPTION OF DRAWINGS

FIG. 1A-C provides hemical structures of (A) PAF-1, (B) functionalized PAF-1 (R=polyamine), and (C) representative appended polyamines.

FIG. 2 shows Chemical structures of representative membrane polymers.

FIG. 3 shows thermogravimetric analysis (TGA) decomposition profiles (5° C./min ramp rate with flowing N₂) of PAF-1 powder and fabricated membranes with different PAF wt % loadings in 6FDA-DAM (top), cellulose acetate (middle), or Matrimid® (bottom). Higher remaining masses were observed at 600° C. for membranes fabricated with higher PAF-1 mass loadings, matching expected trends due to the higher thermal stability of PAF-1 relative to the membrane polymers.

FIG. 4 shows cross-sectional scanning electron micrograph of (top-left) a neat 6FDA-DAM membrane, (top-right) 10 wt % PAF-1 in 6FDA-DAM membrane, (bottom-left) 20 wt % PAF-1 in 6FDA-DAM membrane, and (bottom-right) zoom-in of the same 20 wt % PAF-1 in 6FDA-DAM membrane. The composite PAF membranes feature dispersed PAF particles that are well-integrated in the membrane polymer matrix without any significant agglomerations or sieve-in-a-cage interfaces. Scale bars in the top and bottom-left micrographs: 500 nm; scale bar in bottom-right micrograph: 200 nm.

FIG. 5 shows performances of 6FDA-DAM-based membranes at 35° C. and 2 bar feed pressure relative to the polymer upper bounds (gray lines) for various gas pairs. Open circles represent the neat polymer membrane without PAFs; closed squares represent 10 wt % PAF-1 membranes; closed stars represent 20 wt % PAF-1 membranes. Selectivities were calculated as the ratio of the single-gas permeabilities between the two respective gases. Mean values determined from two independent samples are shown. Error bars representing the range of obtained values were smaller than the displayed symbol sizes.

FIG. 6 shows single-component gas permeability data for neat (open circles), 10 wt % PAF-1 (closed squares), and 20 wt % PAF-1 (closed stars) 6FDA-DAM membranes at 35° C. and various feed pressures.

FIG. 7 provides gas permeation selectivity data for neat (open circles), 10 wt % PAF-1 (closed squares), and 20 wt % PAF-1 (closed stars) 6FDA-DAM membranes at 35° C. and various feed pressures. Selectivities were calculated as the ratio of the single-gas permeabilities between the two respective gases.

FIG. 8 shows gas adsorption isotherms at 35° C. for bulk PAF-1 powder. All gas adsorption isotherms followed linear profiles that suggest weak physisorption rather than selective chemisorption.

FIG. 9 shows Gas adsorption isotherms at 35° C. for 6FDA-DAM-based membranes. Open circles represent the neat polymer membrane without PAFs; closed triangles represent 10 wt % PAF-1 membranes; closed stars represent 20 wt % PAF-1 membranes.

FIG. 10 shows Comparison of predicted (gray lines) CH₄ (Top) and O₂ (Bottom) adsorption isotherms for a 20 wt % PAF-1 in 6FDA-DAM membrane to their measured isotherms (closed stars) at 35° C. The predicted isotherms were calculated as the weighted-average uptake between PAF-1 powder and neat 6FDA-DAM membrane (i.e., by adding 20% of the obtained bulk PAF-1 gas uptake value to 80% of the obtained neat 6FDA-DAM gas uptake value). The close agreement between the predicted and measured isotherms indicates that essentially all PAFs in the membranes are accessible for gas transport.

FIG. 11 shows Gas (top) solubilities and (bottom) diffusion coefficients at 1 bar and 35° C. in 6FDA-DAM membranes consisting of varied PAF loadings. Solubilities were determined from equilibrium adsorption isotherms, while diffusivities were calculated using the solution-diffusion model. Membrane densities used to calculate solubilities were determined based on the density of bulk PAF-1, density of bulk membrane polymer, and PAF-1 wt % loading (see Table 1).

FIG. 12 shows Argon adsorption isotherms at 87 K for PAF-1 (top). Filled symbols represent adsorption; open symbols represent desorption. Calculated pore size distributions of PAF-1 (bottom) determined from the argon adsorption isotherms.

FIG. 13 shows Performances of cellulose acetate-based membranes at 35° C. and 2 bar feed pressure relative to the polymer upper bounds (gray lines) for various gas pairs. Open circles represent the neat polymer membrane without PAFs; closed triangles represent 5 wt % PAF-1 membranes; closed squares represent 10 wt % PAF-1 membranes. Selectivities were calculated as the ratio of the single-gas permeabilities between the two respective gases.

FIG. 14 shows Performances of Matrimid®-based membranes at 35° C. and 2 bar feed pressure relative to the polymer upper bounds (gray lines) for various gas pairs.² Open circles represent the neat polymer membrane without PAFs; closed triangles represent 5 wt % PAF-1 membranes. Selectivities were calculated as the ratio of the single-gas permeabilities between the two respective gases.

FIG. 15 shows Single-component gas permeability data for neat (open circles), 5 wt % PAF-1 (closed triangles), 10 wt % PAF-1 (closed squares), and 20 wt % PAF-1 (closed stars) cellulose acetate membranes at 35° C. and various feed pressures.

FIG. 16 shows Gas permeation selectivity data for neat (open circles), 5 wt % PAF-1 (closed triangles), 10 wt % PAF-1 (closed squares), and 20 wt % PAF-1 (closed stars) cellulose acetate membranes at 35° C. and various feed pressures. Selectivities were calculated as the ratio of the single-gas permeabilities between the two respective gases.

FIG. 17 shows Single-component gas permeability data for neat (open circles) and 5 wt % PAF-1 (closed triangles) Matrimid® 5218 membranes at 35° C. and various feed pressures.

FIG. 18 shows Gas permeation selectivity data for neat (open circles) and 5 wt % PAF-1 (closed triangles) Matrimid® 5218 membranes at 35° C. and various feed pressures. Selectivities were calculated as the ratio of the single-gas permeabilities between the two respective gases.

FIG. 19 shows Gas adsorption isotherms at 35° C. for cellulose acetate-based membranes. Open circles represent the neat polymer membrane without PAFs; closed triangles represent 5 wt % PAF-1 membranes; closed squares represent 10 wt % PAF-1 membranes; closed stars represent 20 wt % PAF-1 membranes.

FIG. 20 shows Gas adsorption isotherms at 35° C. for Matrimid®-based membranes. Open circles represent the neat polymer membrane without PAFs; closed triangles represent 5 wt % PAF-1 membranes; closed squares represent 10 wt % PAF-1 membranes.

FIG. 21 shows Gas (left) solubilities and (right) diffusion coefficients at 1 bar and 35° C. in cellulose acetate membranes consisting of varied PAF loadings. Solubilities were determined from equilibrium adsorption isotherms, while diffusivities were calculated using the solution diffusion model. Membrane densities used to calculate solubilities were determined based on the density of bulk PAF-1, density of bulk membrane polymer, and PAF-1 wt % loading (see Table 1).

FIG. 22 shows Gas (top) solubilities and (bottom) diffusion coefficients at 1 bar and 35° C. in Matrimid® membranes consisting of varied PAF loadings. Solubilities were determined from equilibrium adsorption isotherms, while diffusivities were calculated using the solution diffusion model. Membrane densities used to calculate solubilities were determined based on the density of bulk PAF-1, density of bulk membrane polymer, and PAF-1 wt % loading (see Table 1).

FIG. 23 shows number-averaged particle size distributions of PAF-1 dispersed in solvents with varied boiling points and polarities, as measured by dynamic light scattering. The reported data was compiled from at least three independent measurements. Samples were probe sonicated for 30-60 s immediately before measurements were taken. In each solvent, PAF-1 was dispersed as individual particles between 100-400 nm (gray region), without the detectable presence of any agglomerations of larger sizes.

FIG. 24 shows Photographs of dilute solutions of colloidal PAF-1 dispersed via sonication in various solvents, demonstrating the Tyndall effect from light scattering (wavelength: 650 nm).

FIG. 25 shows Melting point determination of bulk water (top line/curve) and water filled in PAF-1 pores (bottom line/curve). Measurements were obtained via dynamic scanning calorimetry at a ramp rate of 10° C. min-1 in flowing helium. A melting point temperature decrease of ˜24° C. was observed in the water-filled PAF-1 sample (gray band), indicating water nanoconfinement in the PAF-1 pores. The same profile was obtained over five replicate temperature scans. The gray dotted line at 0° C., corresponding to the expected melting onset of bulk water, is included for reference. The large peak around 0° C. in the water-loaded PAF-1 spectrum corresponds to bulk water between PAF-1 particles in the sample.

FIG. 26 shows Single-component CO₂ permeabilities at 35° C. through a neat 6FDA-DAM membrane (black circles) or 20 wt % PAF-1-DETA in 6FDA-DAM membrane (red squares), normalized to the permeabilities measured at 1 bar.

FIG. 27 shows Performances of 6FDA-DAM-based membranes at 35° C. and 2 bar feed pressure relative to the polymer upper bounds (gray lines) for (left) CO₂/CH₄ and (right) CO₂/N₂·² Open circles represent the neat polymer membrane without PAFs; closed symbols represent 6FDA-DAM membranes consisting of 20 wt % PAF-1-R (R=EDA, DETA, or TAEA polyamines; see FIG. 1c). Selectivities were calculated as the ratio of the single-gas permeabilities between the two respective gases.

### DETAILED DESCRIPTION

As used herein and in the appended claims, the singular forms “a,” “an,” and “the” include plural referents unless the context clearly dictates otherwise. Thus, for example, reference to “a cell” includes a plurality of such cells and reference to “the fragment” includes reference to one or more fragments and equivalents thereof known to those skilled in the art, and so forth.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Unless defined otherwise, all technical and scientific terms used herein have the same meaning as commonly understood to one of ordinary skill in the art to which this disclosure belongs. Although many methods and reagents are similar or equivalent to those described herein, the exemplary methods and materials are disclosed herein.

All publications mentioned herein are incorporated herein by reference in full for the purpose of describing and disclosing the methodologies, which might be used in connection with the description herein. Moreover, with respect to any term that is presented in one or more publications that is similar to, or identical with, a term that has been expressly defined in this disclosure, the definition of the term as expressly provided in this disclosure will control in all respects.

It should be understood that this disclosure is not limited to the particular methodology, protocols, and reagents, etc., described herein and as such may vary. The terminology used herein is for the purpose of describing particular embodiments or aspects only and is not intended to limit the scope of the present disclosure.

The term “about,” as used herein can mean within an acceptable error range for the particular value as determined by one of ordinary skill in the art, which can depend in part on how the value is measured or determined, e.g., the limitations of the measurement system. Other than in the operating examples, or where otherwise indicated, all numbers expressing quantities of ingredients or reaction conditions used herein should be understood as modified in all instances by the term “about.” The term “about” when used to described the present invention, in connection with percentages means±1%. Alternatively, “about” can mean a range of plus or minus 20%, plus or minus 10%, plus or minus 5%, or plus or minus 1% of a given value. Alternatively, particularly with respect to biological systems or processes, the term can mean within an order of magnitude, within 5-fold, or within 2-fold, of a value. Where particular values are described in the application and claims, unless otherwise stated the term “about” meaning within an acceptable error range for the particular value can be assumed. Also, where ranges and/or subranges of values are provided, the ranges and/or subranges can include the endpoints of the ranges and/or subranges. In some cases, variations can include an amount or concentration of 20%, 10%, 5%, 1%, 0.5%, or even 0.1% of the specified amount.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein an “absorbent” refers to a molecular entity that can effectively bind and separate from a mixture of molecular agents a desire agent. In certain embodiments, an absorbent is a porous particle. In certain embodiments, an absorbent is a porous aromatic framework (PAF) particle. In certain embodiments, an absorbent is functionalized to be selective for a particular molecular entity. In certain embodiments, the absorbent is functionalized with one or more functional groups selected from—ion-exchange groups (e.g., sulfonate), amines, polyamines, carboxylic acids, crosslinkers, other hydrogen-bonding groups (e.g., hydroxyls, polyols, ketones), and metal-binding groups (e.g., thiol).

As used herein a “fluid” refers to a liquid or gas. The fluid can be a multicomponent fluid containing a plurality of molecular entities.

As used herein a “membrane” refers to a permeable, selectively permeable or non-permeable film that can be used to divide or separate a first fluid from a second fluid.

The term “porous aromatic framework” or “PAF”, refers to a framework characterized by a rigid aromatic open-framework structure constructed by covalent bonds (Ben et al., 2009, Angew. Chem., Intl Ed. 48:9457; Ren et al., 2010, Chem. Commun. 46:291; Peng et al., 2011, Dalton Trans. 40:2720; Ben et al., 2011, Energy Environ. Sci. 4:3991; Ben et al., J. Mater. Chem. 21:18208; Ren et al., J. Mater. Chem. 21:10348; Yuan et al., 2011, J. Mater. Chem. 21:13498; Zhao et al., 2011, Chem. Commun. 47:6389; Ben & Qiu, 2012, Cryst Eng Comm, DOI:10.1039/c2ce25409c). PAFs show high surface areas and excellent physicochemical stability, generally with long range orders and, to a certain extent, an amorphous nature. Porous aromatic frameworks lack the extended conjugation found in conjugated microporous polymers. A porous aromatic framework can have a surface area from about 50 m²/g to about 7,000 m²/g, about 80 m²/g to about 1,000 m²/g, 1,000 m²/g to about 6,000 m²/g, or about 1,500 m²/g to about 5,000 m²/g (or any range or value between the foregoing). A PAF can have a pore width of about 7 angstroms to about 30 angstroms (e.g., 10, 15, 20, 25 angstroms of any value between any of the foregoing). PAFs can have a differential pore volume of 0.02 to 0.30 cm³gÅ⁻¹ (e.g., 0.02, 0.05, 0.10, 0.15, 0.20, 0.25 cm³g⁻¹ Å⁻¹ of any value between any of the foregoing values). PAFs are a class of porous polymers and porous organic frameworks that feature a high-porosity, typically diamondoid-like structure composed of organic nodes covalently coupled to aromatic linkages.

Ion-exchange membranes are dense, semi-permeable membranes made up of polymers with fixed charges. As such, ion-exchange membranes selectively reject co-ions from transporting through the membrane while permitting the transport of counterions. As an example, cation-exchange membranes feature fixed anionic groups (e.g., sulfonates) that allow the transport of cations while electrostatically rejecting anions. This high selectivity between co-ions and counterions has motivated the use of ion-exchange membranes in numerous industrial applications, such as for water desalination, electrolysis, diffusion dialysis, fuel cell technologies, and membrane bioreactors. However, conventional charged membranes face an ion permeability-selectivity tradeoff, where higher swelling leads to a decrease in ion selectivity but enlarges free volume pathways to increase ion permeability and water uptake. Moreover, the relatively low chemical stability and pH stability of traditional charged membranes remain major challenges in their development.

To address the issues of current technologies, the disclosure investigated the use of porous aromatic framework (PAF) fillers, which are formed by organic nodes and aromatic linkers that are chemically similar to the polymer matrix to allow optimal compatibility. These frameworks create diamondoid-like structures with static voids that would allow for high diffusion rates in composite membranes due to their high porosity. PAFs offer exceptional physical and chemical stability due to the irreversible covalent bonding of the organic node to linker. Furthermore, the flexible, amorphous nature of this material is more desirable compared to rigid, inorganic materials such as zeolites, which have shown to lead to membrane embrittlement and decreases in mechanical stability upon their incorporation. The use of PAF frameworks decreases aging while increasing permeability and separation performance in multiple applications of gas separations, pervaporation, and water purification. These frameworks can also be incorporated into glassy, nonporous polymers. The resulting PAF composite membranes exhibit increased free volume and diffusivity enhancements owing to the ultrahigh porosities of the PAF fillers, while also retaining selectivity as a result of the strong chemical compatibility between the PAF filler and polymer matrix. Further studies of these materials also reveal unique physiochemical properties of these frameworks that allows for the generalizability of this filler in various gas separation applications. The utilization of PAFs with high permanent porosity allows for tunability of diffusivity of permeating species in composite membranes without the need for exotic polymers with highly rigid backbones or bulky side-chains. The static free volume from the PAFs in the composite membranes further support this approach for the improvement of membrane technology in large-scale application.

The disclosure provides a generalizable approach to tune the diffusivity and solubility components of membranes for enhanced performance. Porous aromatic framework (PAF) fillers were incorporated into various membrane matrices. These composites were shown to have increased permeation rates with minimal to no decreases in selectivity. These improvements were shown to be due to the ultrahigh porosity, strong chemical compatibility, and unique physicochemical properties of the PAF fillers. Membrane permeability increases as high as 520% with maintained selectivities were observed upon PAF incorporation for various industrially relevant gas mixtures (CO₂/CH₄, CO₂/N₂, H₂/N₂, H₂/CH₄, He/N₂, He/CH₄, O₂/N₂, and C₂H₄/C₂H₆). Further functionalization of these PAF fillers were also shown to increase permeation rates while also increasing chemical stability of the membrane structure, enabling plasticization resistance at high pressures of CO₂. The coupling of increased permeation and chemical stability uniquely addresses multiple material limitations that are required for commercial implementation of membranes.

The disclosure provides for composite membranes. The composite membranes of the disclosure are incorporated with tunable absorbents. In some embodiment, the composite membranes comprise porous aromatic frameworks (PAFs), porous polymer networks (PPNs) and/or porous organic frameworks (POFs). In certain embodiments, PAFs possess a high-porosity, and have a diamondoid-like structure that comprise organic nodes covalently and irreversibly coupled to aromatic linkages. As a result, PAFs display exceptional hydrothermal and chemical stabilities, such as stability in boiling water, concentrated acids and bases, and organic solvents. Furthermore, PAFs comprise chemical compositions similar to those of polymer matrices. For example, the disclosure demonstrates that strong PAF-polymer interfacial interactions bestow improved stability and transport properties to charged membranes. In contrast, other highly tunable nanomaterial classes often lack stability in water and compatibility with polymer matrices due to inorganic parts, limiting their development for composite charged membranes.

A PAF, POF or PPN can comprise an organic node linked together by linking ligands, wherein the series of nodes have a formula selected from Formula Ia:

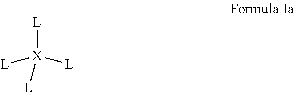

wherein, X is selected from C, B⁻ and P⁺; or
wherein the series of nodes have a formula of Formula Ib:

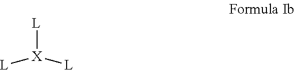

wherein, X is selected from N, Si, Ge, a benzene and Al; and L is a linking ligand; and wherein the linking ligand has a structure of Formula II or III:

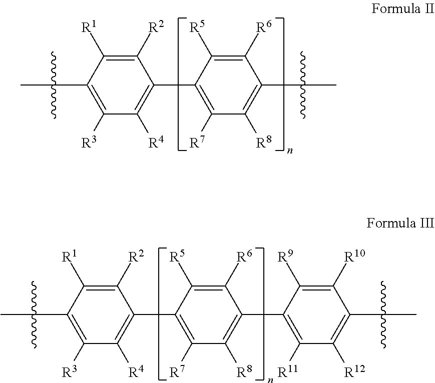

wherein, R¹-R¹² are independently selected from H, or a polyamine; and n is an integer selected from 0, 1, 2, 3, 4, or 5.

In certain embodiments, the composite comprises PAFs selected from the group consisting of PAF-1, PAF-1-CH₃, PAF-1-EDA, PAF-1-DETA, and PAF-1-TAEA:

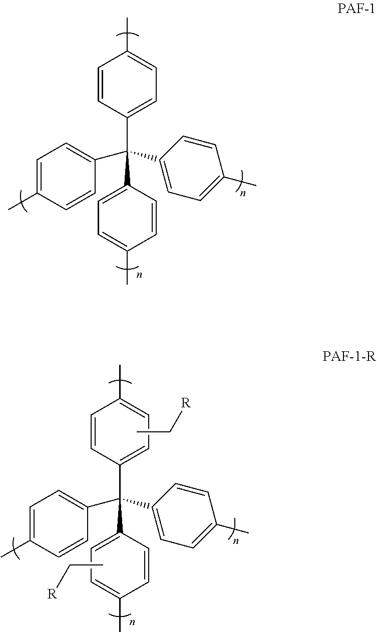

| Name | R group is: |
|---|---|
| PAF-1-EDA | 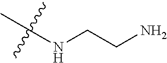 [SMILES: *NCCN] |
| PAF1-DETA | 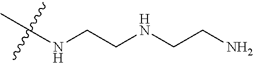 [SMILES: *NCCNCCN] |
| PAF-1-TAEA | 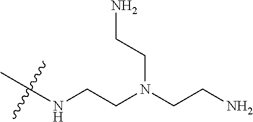 [SMILES: *NCCN(CCN)CCN] |
| PAF-1-CH₃ | —CH₃ |

In some embodiments, a porous polymer network is formed from the monomer of Formulas (IV), (V), (VI) or (VII):

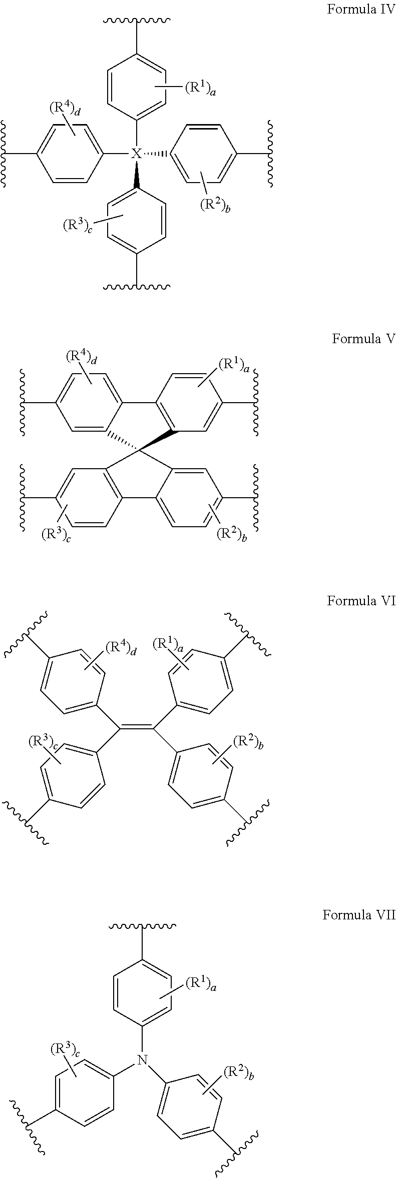

wherein, X is selected from C, Si, and a three-dimensional polycyclic cycloalkyl moiety, R¹, R², R³ and R⁴ are independently selected from an alkyl thioether, a dialkyl thioether, 2,5-dithiahexane, 3,4-dithiahexane, 4,5-dithiahexane, (2-methoxyethyl) (methyl)sulfane, (2-methoxyethyl)(methyl)sulfane, 3-(methylthio)propanoic acid, ethylglycine, N-hydroxy-2-(methylamino)acetamide, 2-thiopentane, N-hydroxyacetamide and 2-methylhydrazine-1-carbothioamide, and a, b, c and d are independently selected from the integers 0, 1, 2, 3, and 4, such that when a, b, c, or d is greater than 1, each R¹, R², R³ and R⁴, respectively, is independently selected.

In still another embodiment, a porous polymer network useful in the composites of the disclosure comprise a structure of Formula VIII:

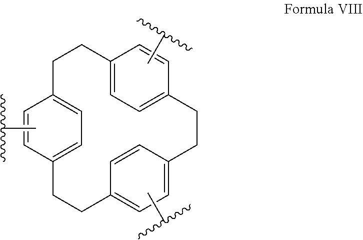

The disclosure provides a composite comprising a polymer/membrane matrix that contains or is embedded with one or more absorbents porous aromatic frameworks (PAFs, POFs and/or PPNs) that selectively binds to one or more targeted ions or organic molecules. In another or further embodiment, the polymer/membrane matrix comprises ion exchange polymer/membrane matrix materials. In one embodiment, the composite membrane contains from 5 wt % to 40 wt % of the one or more PAFs, POFs, and/or PPNs.

Exemplary polymers that may be used to construct the composite membranes include, but are not limited to: polyolefins such as polyethylene, polypropylene, polybutene-1, and poly(4-methyl pentene-1), including polyvinyls and fluoropolymer variants thereof, for example polyvinylidene fluoride (PVDF), polytetrafluoroethylene (PTFE), polyvinyl chloride, polyvinyl fluoride, polyvinylidene chloride, polyvinylidene fluoride, polyvinyl alcohol, polyvinyl ester (e.g., polyvinyl acetate and polyvinyl propionate), polyvinyl pyridine, polyvinyl pyrrolidone, polyvinyl ether, polyvinyl ketone, polyvinyl aldehyde (e.g., polyvinyl formal and polyvinyl butyral), polyvinyl amide, polyvinyl amine, polyvinyl urethane, polyvinyl urea, polyvinyl phosphate, and polyvinyl sulfate; polystyrene (e.g., isotactic polystyrene and syndiotactic polystyrene), including styrene-containing copolymers such as acrylonitrilestyrene copolymers, styrene-butadiene copolymers and styrene-vinylbenzylhalide copolymers; thermoplastic elastomers (TPE); silicones such as polydimethylsiloxane (PDMS) and polymethylphenylsilicone (PMPS); polyacetylenes such as polytrimethylsilylpropyne; polysulfones including polyethersulfones (PESs) as well as sulfonated PESs, with specific mention being made to poly(1,4-phenylene ether-ether-sulfone), poly(1-hexadecene-sulfone), poly(1-tetradecene-sulfone), poly(oxy-1,4phenylenesulfonyl-1,4-phenylene), poly(oxy-1,4-phenylenesulfonyl-1,4-phenylene), poly(oxy-1,4-phenylenesulfonyl-1,4-phenylene), poly(oxy-1,4-phenylenesulfonyl-1,4-phenylene), polyphenylsulfone, and ULTRASON S 6010 from BASF; polysulfonamides such as poly[1-[4-(3-carboxy-hydroxyphenylazo)benzenesulfonamido]-1,2-ethanediyl]-) polyacetals; polyethers; polyethylenimines; polycarbonates; cellulosic polymers such as cellulose acetate, cellulose triacetate, cellulose acetate-butyrate, cellulose propionate, ethyl cellulose, methyl cellulose, and nitrocellulose; polyamides including aromatic polyamides and aliphatic polyamides, such as Nylon 6 and polyphthalamide; polyimides with specific mention being made to KAPTON (poly(4,4′-oxydiphenylene-pyromellitimide) by DuPont, MATRIMID® by Huntsman Advanced Materials, P84 by HP Polymers GmbH, poly(3,3′,4,4′-benzophenone tetracarboxylic dianhydride-pyromellitic dianhydride-3,3′,5,5′-tetramethyl-4,4′-methylene dianiline) (or poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (or poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (or poly(DSDA-TMMDA)), poly(3,3′,4,4′-benzophenone tetracarboxylic dianhydride-3,3′,5,5′-tetramethyl-4,4′-methylene dianiline) (or poly(BTDA-TMMDA)), poly(3,3′, 4,4′-diphenylsulfone tetracarboxylic dianhydride-pyromellitic dianhydride-3,3′, 5,5′-tetramethyl-4,4′-methylene dianiline) (or poly(DSDA-PMDA-TMMDA)), and poly[2,2′-bis-(3,4-dicarboxyphenyl) hexafluoropropane dianhydride-2,2-bis(3-amino-4-hydroxyphenyl)-hexafluoropropane](or poly(6FDA-APAF)), poly[2,2′-bis-(3,4-dicarboxyphenyl) hexafluoropropane dianhydride-2,4,6-trimethyl-1,3-phenylenediamine](or poly(6FDA-DAM), poly[3,3′, 4,4′-benzophenonetetracarboxylic dianhydride-2,2-bis(3-amino-4-hydroxyphenyl)-hexafluoropropane](or poly(BTDA-APAF)), poly(3,3′, 4,4′-benzophenonetetracarboxylic dianhydride-3,3′-dihydroxy-4,4′-diamino-biphenyl) (or poly(BTDA-HAB)), poly[4,4′-oxydiphthalic anhydride-2,2-bis(3-amino-4-hydroxyphenyl)-hexafluoropropane](or poly(ODPA-APAF)), poly[3,3′, 4,4′-diphenylsulfone tetracarboxylic dianhydride-2,2-bis(3-amino-4-hydroxyphenyl)-hexafluoropropane](or poly(DSDA-APAF)), poly(3,3′, 4,4′-diphenylsulfone tetracarboxylic dianhydride-3,3′-dihydroxy-4,4′-diamino-biphenyl) (or poly(DSDA-HAB)), poly[2,2′-bis-(3,4-dicarboxyphenyl) hexafluoropropane dianhydride-3,3′,4,4′-benzophenonetetracarboxylic dianhydride-2,2-bis(3-amino-4-hydroxyphenyl)-hexafluoropropane](or poly(6FDA-BTDA-APAF)), poly[4,4′-oxydiphthalic anhydride-2,2-bis(3-amino-4-hydroxyphenyl)-hexafluoropropane-3,3′-dihydro-xy-4,4′-diamino-biphenyl](or poly(ODPA-APAF-HAB)), poly[3,3′, 4,4′-benzophenonetetracarboxylic dianhydride-2,2-bis(3-amino-4-hydroxyphenyl)-hexafluoropropane-3,3′-dihyd-roxy-4,4′-diamino-biphenyl](or poly(BTDA-APAF-HAB)), poly[2,2′-bis-(3,4-dicarboxyphenyl) hexafluoropropane dianhydride-3,3′-dihydroxy-4,4′-diamino-biphenyl](or poly(6FDA-HAB)), and poly(4,4′-bisphenol A dianhydride-3,3′, 4,4′-benzophenonetetracarboxylic dianhydride-2,2-bis(3-amino-4-hydroxyphenyl)-hexafluoropropane) (or poly(BPADA-BTDA-APAF)); polyetherimides such as ULTEM products manufactured by Sabic Innovative Plastics; polyamide imides; polyketones; polyether ketones such as polyether ether ketone, sulfonated polyether ether ketone and the like; polyarylene oxides such as polyphenylene oxide, polyxylene oxide, sulfonated polyxylene oxide and brominated polyxylene oxide; polyurethanes; polyureas; polyazomethines; polyesters including polyarylates such as polyethylene terephthalate and polyphenylene terephthalate; acrylates such as polyalkyl (meth)acrylate, polyacrylate, polyacrylate-polyacrylamide copolymers; polysulfides; heterocyclic thermoplastics such as polybenzimidazoles, polyoxadiazoles, polytriazoles, polybenzoxazole, and polybenzimidazole; polycarbodiimides; polyphosphazines; polyhydrazides; and copolymers thereof, including block copolymers, grafts, and blends thereof.

In one embodiment, the disclosure provides a composite membrane comprising a plurality of absorbents (e.g., PAFs, POFs, and/or PPNs) that are selective for one or more agents or contaminants in a fluid stream. The absorbent may be uniformly distributed in the membrane or may be non-uniformly distributed. The plurality of absorbents may have a uniform pore size or a non-uniform pore size. By “uniform pore size” is meant that the pore size between two absorbents does not differ by more than 0.1%, 0.5% or 1%. In one embodiment, the anionic membrane contains from 5 wt % to 40 wt % of the one or more absorbents (e.g., PAFs).

The disclosure provides for composite membranes that have incorporated PAFs, POFs, PPNs and any combination thereof. The composite membranes of the disclosure have use in many possible applications, including for water treatment, ion-exchange, and electrochemical applications. Moreover, the composite membranes of the disclosure can be made to have specific selectivities for ions based upon the choice of incorporated PAFs, POFs, and/or PPNs. The disclosure demonstrates, for example, that the exceptional adsorption performances of PAFs are retained upon incorporation into membrane matrices, thus, demonstrating the broad potential of PAF-incorporated charged membranes.

The adsorbent material can be selected according to the service needs, particularly the composition of the incoming fluid stream, the contaminants or agents which are to be removed and the desired service conditions, e.g., incoming gas pressure and temperature, desired product composition and pressure.

Various membranes can be used in the methods and compositions of the disclosure and can be selected for their particular use and functionalized with an absorbent accordingly. Membranes suitable for use in the disclosed composites and fluid separation module include membranes comprising polyolefins such as polyethylene, polypropylene, polybutene-1, and poly(4-methyl pentene-1), including polyvinyls and fluoropolymer variants thereof, for example polyvinylidene fluoride (PVDF), polytetrafluoroethylene (PTFE), polyvinyl chloride, polyvinyl fluoride, polyvinylidene chloride, polyvinylidene fluoride, polyvinyl alcohol, polyvinyl ester (e.g., polyvinyl acetate and polyvinyl propionate), polyvinyl pyridine, polyvinyl pyrrolidone, polyvinyl ether, polyvinyl ketone, polyvinyl aldehyde (e.g., polyvinyl formal and polyvinyl butyral), polyvinyl amide, polyvinyl amine, polyvinyl urethane, polyvinyl urea, polyvinyl phosphate, and polyvinyl sulfate; polystyrene (e.g., isotactic polystyrene and syndiotactic polystyrene), including styrene-containing copolymers such as acrylonitrilestyrene copolymers, styrene-butadiene copolymers and styrene-vinylbenzylhalide copolymers; thermoplastic elastomers (TPE); silicones such as polydimethylsiloxane (PDMS) and polymethylphenylsilicone (PMPS); polyacetylenes such as polytrimethylsilylpropyne; polysulfones including polyethersulfones (PESs) as well as sulfonated PESs, with specific mention being made to poly(1,4-phenylene ether-ether-sulfone), poly(1-hexadecene-sulfone), poly(1-tetradecene-sulfone), poly(oxy-1,4phenylenesulfonyl-1,4-phenylene), poly(oxy-1,4-phenylenesulfonyl-1,4-phenylene), poly(oxy-1,4-phenylenesulfonyl-1,4-phenylene), poly(oxy-1,4-phenylenesulfonyl-1,4-phenylene), polyphenylsulfone, and ULTRASON S 6010 from BASF; polysulfonamides such as poly[1-[4-(3-carboxy-hydroxyphenylazo)benzenesulfonamido]-1,2-ethanediyl]-polyacetals; polyethers; polyethylenimines; polycarbonates; cellulosic polymers such as cellulose acetate, cellulose triacetate, cellulose acetate-butyrate, cellulose propionate, ethyl cellulose, methyl cellulose, and nitrocellulose; polyamides including aromatic polyamides and aliphatic polyamides, such as Nylon 6 and polyphthalamide; polyimides with specific mention being made to KAPTON (poly(4,4′-oxydiphenylene-pyromellitimide) by DuPont, MATRIMID by Huntsman Advanced Materials, P84 by HP Polymers GmbH, poly(3,3′,4,4′-benzophenone tetracarboxylic dianhydride-pyromellitic dianhydride-3,3′,5,5′-tetramethyl-4,4′-methylene dianiline) (or poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (or poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (or poly(DSDA-TMMDA)), poly(3,3′,4,4′-benzophenone tetracarboxylic dianhydride-3,3′,5,5′-tetramethyl-4,4′-methylene dianiline) (or poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (or poly(DSDA-PMDA-TMMDA)), and poly[2,2′-bis-(3,4-dicarboxyphenyl) hexafluoropropane dianhydride-2,2-bis(3-amino-4-hydroxyphenyl)-hexafluoropropane](or poly(6FDA-APAF)), poly[2,2′-bis-(3,4-dicarboxyphenyl) hexafluoropropane dianhydride-2,4,6-trimethyl-1,3-phenylenediamine](or poly(6FDA-DAM), poly[3,3′,4,4′-benzophenonetetracarboxylic dianhydride-2,2-bis(3-amino-4-hydroxyphenyl)-hexafluoropropane](or poly(BTDA-APAF)), poly(3,3′,4,4′-benzophenonetetracarboxylic dianhydride-3,3′-dihydroxy-4,4′-diamino-biphenyl) (or poly(BTDA-HAB)), poly[4,4′-oxydiphthalic anhydride-2,2-bis(3-amino-4-hydroxyphenyl)-hexafluoropropane](or poly(ODPA-APAF)), poly[3,3′,4,4′-diphenylsulfone tetracarboxylic dianhydride-2,2-bis(3-amino-4-hydroxyphenyl)-hexafluoropropane](or poly(DSDA-APAF)), poly(3,3′,4,4′-diphenylsulfone tetracarboxylic dianhydride-3,3′-dihydroxy-4,4′-diamino-biphenyl) (or poly(DSDA-HAB)), poly[2,2′-bis-(3,4-dicarboxyphenyl) hexafluoropropane dianhydride-3,3′,4,4′-benzophenonetetracarboxylic dianhydride-2,2-bis(3-amino-4-hydroxyphenyl)-hexafluoropropane](or poly(6FDA-BTDA-APAF)), poly[4,4′-oxydiphthalic anhydride-2,2-bis(3-amino-4-hydroxyphenyl)-hexafluoropropane-3,3′-dihydro-xy-4,4′-diamino-biphenyl](or poly(ODPA-APAF-HAB)), poly[3,3′,4,4′-benzophenonetetracarboxylic dianhydride-2,2-bis(3-amino-4-hydroxyphenyl)-hexafluoropropane-3,3′-dihyd-roxy-4,4′-diamino-biphenyl](or poly(BTDA-APAF-HAB)), poly[2,2′-bis-(3,4-dicarboxyphenyl) hexafluoropropane dianhydride-3,3′-dihydroxy-4,4′-diamino-biphenyl](or poly(6FDA-HAB)), and poly(4,4′-bisphenol A dianhydride-3,3′,4,4′-benzophenonetetracarboxylic dianhydride-2,2-bis(3-amino-4-hydroxyphenyl)-hexafluoropropane) (or poly(BPADA-BTDA-APAF)); polyetherimides such as ULTEM products manufactured by Sabic Innovative Plastics; polyamide imides; polyketones; polyether ketones such as polyether ether ketone, sulfonated polyether ether ketone and the like; polyarylene oxides such as polyphenylene oxide, polyxylene oxide, sulfonated polyxylene oxide and brominated polyxylene oxide; polyurethanes; polyureas; polyazomethines; polyesters including polyarylates such as polyethylene terephthalate and polyphenylene terephthalate; acrylates such as polyalkyl (meth)acrylate, polyacrylate, polyacrylate-polyacrylamide copolymers; polysulfides; heterocyclic thermoplastics such as polybenzimidazoles, polyoxadiazoles, polytriazoles, polybenzoxazole, and polybenzimidazole; polycarbodiimides; polyphosphazines; polyhydrazides; and copolymers thereof, including block copolymers, grafts, and blends thereof.

PAF/POF/PPN-incorporated membranes advantageously exhibit an inverse effect to the typical permeability-selectivity tradeoff shown in conventional charged membranes. PAFs, POFs and/or PPNs add porosity to the membranes to elevate their water uptake, and these high-diffusivity pathways in the pores lead to heightened ion conductivities in, e.g., PAF-embedded membranes, compared to neat, conventional charged membranes. However, while increased water uptake (and thus permeability) in charged membranes typically leads to increased swelling (and thus decreased selectivity), strong polymer crosslinking interactions with the PAFs, POFs, and/or PPNs diminish swelling in water. This reduced swelling prevents the formation of non-selective pathways in the polymer matrix.

This disclosure can be applied generally to various gas separation membrane technologies. Examples of potential applications and variations of this technology include, but are not limited to, the following discussions.

The composite membranes of the disclosure can be used in the separations or isolation of carbon dioxide. Example CO₂-containing mixtures in which PAF/POF/PPN membranes can be used to improve separations, such as for removing CO₂ impurities and/or ultimately sequestering CO₂. Such composites and methods would be useful in coal flue gas, oxy-fuel combustion, air, biogas, and natural gas. Amine-based functional groups that can allow facilitated transport of CO₂ can also be appended onto PAF fillers to increase CO₂ selectivity.

Separations targeting the isolation of dihydrogen. Example H₂-containing mixtures in which PAF/POF/PPN membranes can be used to improve separations, such as for improving the recovery of H₂, include syngas, ammonia synthesis purge gas, and refinery fuel gas streams.

The composite membranes of the disclosure can be used in separations targeting the isolation of helium. Example He-containing mixtures in which PAF/POF/PPN membranes can be used to improve separations, such as for improving the recovery of helium, included in natural gas and the off gas from nitrogen rejection units used in natural gas processing.

The composite membranes of the disclosure can be used in separations targeting the isolation of oxygen. Example O₂-containing mixtures in which PAF/POF/PPN membranes can be used to improve separations, such as for improving the recovery of oxygen found in ambient air.

The composite membranes of the disclosure can be used in Olefin/paraffin separations. For example, to improve membrane olefin permeabilities, non-selective PAFs can be incorporated into olefin-selective polymer matrices. To improve membrane olefin selectivities, olefin-selective PAFs can be incorporated into membrane polymers. Examples of facilitated-transport, olefin-selective PAF/POF/PPN include, e.g., PAFs that contain metals with n-complexation capabilities (e.g., Ag(I) or Cu(I)), increasing olefin solubility in the membranes. These metals can be affixed onto PAFs using methods such as ion-exchange or metalation using groups such as catechols or thiols.

The composite membranes of the disclosure can be used in separations of gas mixtures that contain humidity. Because, e.g., PAFs are constructed of carbon and hydrogen, PAFs are not expected to interact differently with various gases upon exposure to water. In comparison, other high-performance membrane fillers, such as many metal-organic frameworks, degrade or lose performance upon exposure to water.

The composite membranes of the disclosure can be used in separations of liquid mixtures such as pervaporation with organics in water or alcohol mixtures. These separations require high flux rates and chemical stability because of the strongly swelling species. These PAFs, POFs and/or PPNs can be incorporated into commercial membranes to further increase efficiency and stability.

Enhancing plasticization resistance of membranes used for separating gases at higher pressures. As described in the disclosure, crosslinking interactions (e.g., π-π stacking between PAF aromatic groups and polymer matrix aromatic groups, hydrogen-bonding between amines or oxygen-rich groups appended onto PAFs and polar moieties on polymer matrix) improve the mechanical stability of membranes. These mechanical enhancements prevent membrane swelling, and thus prevent formation of non-selective gas transport pathways, at higher gas feed pressures.

In another embodiment of the disclosure, thin-film composites in which PAFs, POFs and/or PPNs are incorporated into the selective layer to achieve the previously described performance enhancements is also provided. These thin-film composites would consist of a thin (e.g., ≤5 μm) membrane attached to a porous mechanical support. The thin membrane would consist of the previously described PAFs blended into a polymer matrix.

The composite PAFs, POFs and/or PPNs membranes of the disclosure can be planar or in some instances molded or folded to a suitable geometry for their intended purpose. For example, PAFs can be incorporated into membrane polymer matrices that are already in a hollow fiber configuration or can be shaped into hollow fiber configurations.

As an alternative PAFs, POFs and/or PPNs membrane fabrication strategy, PAFs, POFs and/or PPNs composite membranes can be fabricated using ultraviolet (UV)-induced polymerization methods. In this strategy, PAFs, POFs and/or PPNs can be dispersed in a solution of polymer crosslinkers, where the membrane polymer is crosslinked around the PAFs, POFs and/or PPNs in a UV curing oven.

For example, a solvent evaporation approach was used to synthesize the membranes (Qian et al., Langmuir, 28:17803-17810, 2012). Chloroform was used as the casting solvent to fabricate membranes based on the 6FDA-DAM and Matrimid® polymers, while THF was used as the casting solvent to synthesize membranes based on cellulose acetate.

Separate solutions of 0.5 wt % of, e.g., a PAF in a casting solvent and 2 wt % of the polymer (e.g., 6FDA-DAM, Matrimid®, or cellulose acetate) in a casting solvent are stirred for a suitable time at ˜450 rpm and room temperature. The PAF/POF/PPN solution is then dispersed via sonication for about 30 min before ˜30% of the polymer solution is added to the PAF solution while stirring. This “priming” step is used to coat the filler with a thin polymer layer, facilitating favorable interactions between the filler and bulk polymer in composite materials. The composite solution is mixed at ˜600 rpm for about 1 h and then sonicated for about 30 min. Afterwards, the remaining polymer solution was added while stirring. The resulting solution was stirred at ˜600 rpm for about 1 h, sonicated for about 30 min, and then further sonicated using a probe sonicator for about 1 min. Following these mixing and sonication steps, no PAF agglomerations should be visible. The dispersed solution is then immediately casted into a borosilicate glass dish, which is then covered with a folded Kimwipe. The glass dish is left at ambient conditions for about 1-2 d to allow the solvent (e.g., CHCl₃ or THF) to evaporate from the casted solution. The resulting films are removed from the glass dishes and placed in a vacuum oven at about 120° C. for about 24 h to remove residual solvent. Dense membrane films are obtained with thicknesses of ˜45±15 μm, as measured using a digital micrometer.

As a material variation, other dense polymer matrices or polymer blend matrices not discussed in this report may be used with PAFs, POFs and/or PPNs incorporation. The polymer matrix selection can especially be judiciously chosen based on the targeted application of the composite membranes; for example, the gas selectivities of the composite membranes will largely be dictated by the choice of polymer matrix. Other polymer examples include polysulfone, polystyrene, polyethylene, polyethylene glycol, crosslinked polyethylene glycol, polyisobutene, poly(phenylene oxide), ethyl acetate, tetrabromopolycarbonate, polyether-block-amide, or polyurethane. Example polymer blends (e.g., block copolymers) include combinations of the polymers previously mentioned. Examples of other polyimides similar to 6FDA-DAM and Matrimid® 5218 that may be used with PAFs for gas separation applications include 6FDA-DAT (6FDA=2,2′-bis-(3,4-dicarboxyphenyl) hexafluoropropane dianhydride; DAT=2,6-diaminotoluene), the copolymer 6FDA-DAT:DAM consisting of different ratios of 6FDA-DAT and 6FDA-DAM, and 6FDA-durene (durene=2,3,5,6-tetramethyl-1,4-phenylenediamine).

Similarly as a material variation, different PAF types other than PAF-1 (e.g., PAF-5) can be implemented into composite gas separation membranes to improve permeability and selectivity performances. Other PAFs that are cheaper to synthesize and/or can be more readily synthesized in larger bulk amounts can also be used. Examples of these cheaper PAF types include Scholl-coupled PAFs such as PAF-42 and PAF-45.

Similarly as a material variation, PAFs functionalized with different chemical groups can be embedded into gas separation membranes to improve separation performances, material stability, and/or plasticization resistance. Examples of functional groups include ion-exchange groups (e.g., sulfonate), amines, polyamines, carboxylic acids, crosslinkers, other hydrogen-bonding groups (e.g., hydroxyls, polyols, ketones), and metal-binding groups (e.g., thiol).

### Examples

Synthesis of PAF-1 particles. Tetrakis(4-bromophenyl)methane was first synthesized as a brownish-red powder. The synthesized tetrakis(4-bromophenyl)methane monomer was then purified via column chromatography (ROCC SiO₂, 60 Å, 40-63 μm) using hexanes as the eluent and recrystallization from N,N-dimethylformamide (DMF). The obtained white powder was washed with ethanol to remove residual DMF before dried under vacuum overnight at 80° C.

To then synthesize PAF-1 using the obtained monomer, dried 2,2′-bipyridyl (1.1 g, 7.3 mmol), 1,5-cyclooctadiene (0.90 mL, 7.3 mmol), and anhydrous DMF (110 mL) was added to a 500-mL two-neck Schlenk flask under an argon atmosphere. The sealed flask was quickly moved to an Ar-purged glove tent, where bis(1,5-cyclooctadiene)nickel(0) (2.0 g, 7.3 mmol) was added. In the glove tent, an air-free, custom-made solid transfer adapter containing the dried tetrakis(4-bromophenyl)methane (0.93 g, 1.5 mmol) was then connected to the flask. The solution was then stirred and heated to 80° C. for 1.5 h to obtain a deep purple solution. The tetrakis(4-bromophenyl)methane was then slowly added to the solution under argon. The solution was further stirred for 16 h at 80° C., after which the solution became black. After slowly cooling to room temperature, hydrochloric acid (6 M, 50 mL) was added dropwise under an ambient air atmosphere. White solids gradually emerged in the solution toward the end of this addition. The solution was then stirred under air for 3 h at room temperature, where the solution slowly converted to a sky blue color after ˜1 h. Unsuccessful syntheses led to a darker, forest green color rather than a turquoise color, possibly resulting from accidental air exposure before the final acid addition. The turquoise solution was filtered, and the collected solids were washed with 250 mL each DMF, methanol, chloroform, dichloromethane, and tetrahydrofuran (THF) before dried under vacuum overnight at 180° C. to obtain ˜450 mg of PAF-1 as an off-white powder.

Carbon and hydrogen elemental analyses were acquired using a PerkinElmer 2400 Series II combustion analyzer. PAF-1 ((C₂₅H₁₆)ₙ) elemental analysis: % calc. C, 94.9, H, 5.1; % found C, 94.7, H, 5.3.

Synthesis of membrane polymers. Matrimid® 5218 was obtained from Membrane Technology and Research (MTR), Inc. Cellulose acetate (average Mₙ=50,000) was purchased from Sigma-Alrich. Both polymers were dried under vacuum for 2 d at 80° C. prior to use.

The polyimide, 6FDA-DAM, was synthesized with standard chemical imidization techniques using 2,2-bis-(3,4-dicarboxyphenyl) hexafluoropropane dianhydride (6FDA) and diaminomesitylene (DAM). The dianhydride 6FDA was purified once by vacuum sublimation, and the diamine DAM was purified five times by vacuum sublimation. A 3-neck 500 mL flask was equipped with a mechanical stirrer and flame-dried under an argon atmosphere. DAM (3.23 g) suspended in 48 mL of anhydrous N-methyl-2-pyrrolidone (NMP) was added to the flask. The mixture was stirred for 20 minutes before solid 6FDA (9.55 g) was quickly added to the flask. The reaction was stirred for 20 hours to form a viscous poly(amic acid) solution. Triethylamine (3 mL) and acetic anhydride (8 mL) were added to the flask as the activating and dehydrating agent, respectively, for the chemical imidization of the poly(amic acid). The solution was then allowed to stir for 20 additional hours to complete the formation of the polyimide. The polyimide was precipitated from solution by slowly pouring the viscous solution into approximately 1 L of methanol, which was stirring at intermediate speeds. Residual reaction solvent was removed from the polyimide by filtering and washing the polymer fibers three times in methanol. The polyimide was then finally heated at 120° C. for 24 hours in a vacuum oven.

Fabrication of membrane films. A solvent evaporation approach was used to synthesize the membranes. Chloroform was used as the casting solvent to fabricate membranes based on the 6FDA-DAM and Matrimid® polymers, while THF was used as the casting solvent to synthesize membranes based on cellulose acetate.

Separate solutions of 0.5 wt % PAF-1 in the aforementioned casting solvent and 2 wt % of the polymer (6FDA-DAM, Matrimid®, or cellulose acetate) in the casting solvent were stirred overnight at ˜450 rpm and room temperature. The PAF-1 solution was then fully dispersed via sonication for 30 min before ˜30% of the polymer solution was added dropwise to the PAF solution while stirring. This “priming” step is used to coat the filler with a thin polymer layer, facilitating favorable interactions between the filler and bulk polymer in composite materials. The composite solution was mixed at ˜600 rpm for 1 h and then sonicated for 30 min. Afterwards, the remaining polymer solution was added dropwise while stirring. The resulting solution was stirred at ˜600 rpm for 1 h, sonicated for 30 min, and then further sonicated using a probe sonicator for 1 min. Following these mixing and sonication steps, no PAF agglomerations could be visibly observed. The dispersed solution was then immediately casted in a fume hood into a homemade borosilicate glass dish, which was then covered with a folded Kimwipe. The glass dish was left undisturbed in the fume hood at ambient conditions for 2 d to allow the solvent (CHCl₃ or THF) to slowly evaporate from the casted solution. The resulting films were carefully removed from the glass dishes and placed in a vacuum oven at 120° C. for 24 h to remove residual solvent. Dense membrane films were then obtained with thicknesses of ˜45±15 μm, as measured using a digital micrometer.

Neat polymer membranes were fabricated using the same method but without the PAF addition and priming steps.

### Material Characterizations of PAF-1, Polymers, and Membrane Films.

Surface areas from N₂ adsorption isotherms. PAF surface areas were measured using 77 K N₂ adsorption isotherms obtained on a Micromeritics ASAP 2420 instrument. Activated samples (˜70 mg) were transferred to a pre-weighed glass analysis tube sealed with a TranSeal. The samples were evacuated ˜24 h on the ASAP 2420 instrument at 180° C. prior to isotherm measurements. The samples were considered fully activated following this drying, given that the outgas rate was less than 2 μbar min⁻¹. Nitrogen adsorption isotherms were obtained using a 77 K liquid-N₂ bath and ultra-high purity grade (99.999%) nitrogen. A molecular cross-sectional area of 16.2 Å² was assumed for N₂.

Pore size distributions from Ar adsorption isotherms. PAF-1 pore size distributions were determined using argon adsorption isotherms at 87 K using otherwise identical methods to the nitrogen adsorption isotherm measurements. Ultra-high purity grade (99.999%) argon and an 87 K liquid-Ar bath was used. A molecular cross-sectional area of 14.2 Å² was assumed for Ar. Pore size distributions were calculated using the MicroActive Version 5.00 software (Micromeritics), using the density functional theory (DFT) method and assuming a slit pore geometry, a carbon slit pore model, and a regularization of 0.10. This model and regularization value provided the best fits (based on lowest root-mean-square error and roughness of distribution) but may not most accurately reflect the actual pore geometries in the materials.

Densities from pycnometry. The PAF-1 and polymer skeletal densities were measured using a helium pycnometer (Micromeritics AccuPyc II 1340). The pycnometer was placed in a N₂-purged glove bag to prevent atmospheric moisture effects. Prior to measurements, PAF-1 and the polymers were ground separately into fine powders. PAF-1 was then dried overnight on a Schlenk line under vacuum at 180° C. The Matrimid® and cellulose acetate polymers were similarly dried overnight at 150° C. and 120° C., respectively. In a N₂-purged glove tent, ˜125 g of the dried PAF-1 material or ˜1 g of the dried polymer was transferred to a 3.5-mL pycnometer sample container and weighed. Each pycnometer measurement consisted of 20 cycles. Measurements in the final five cycles were used for density determination. The recorded skeletal densities of 1.279 g mL⁻¹, 1.324 g mL⁻¹, or 1.445 g mL⁻¹ for Matrimid®, cellulose acetate, or PAF-1 represent the average data from at least four separate pycnometer measurements for each material. The density used for the 6FDA-DAM polymer (1.259 g mL⁻¹) was taken from literature.

To account for porosity in PAF-1 density determination, the bulk density of PAF-1 (0.333 g mL⁻¹) was determined using both the measured skeletal density and the amount of N₂ gas uptake at the highest recorded pressure (66.5 mmol g⁻¹). This P/P₀ value was selected according to reported methods used to determine pore volumes of other highly porous polymeric materials. Volume-based PAF-1 loadings in the membranes were then calculated for each respective PAF-1 wt % loading, using the bulk densities of PAF-1 and the polymers (see Table 1).

As a notable comparison for experimental accuracy, the measured density of the cellulose acetate polymer (1.32 g mL⁻¹) closely aligned with the density reported by the manufacturer (Sigma-Aldrich, 1.3 g mL⁻¹).

Thermogravimetric analysis (TGA) decompositions. TGA decompositions were conducted on a TA Instruments TGA Q5000. Flowing N₂ gas at a ramp rate of 5° C. min-1 was applied.

Particle size measurements from dynamic light scattering (DLS). Number-averaged particle size distributions of PAF-1 in various solvents were determined using a Zetasizer Nano ZS instrument (Malvern Analytical). Samples were prepared by first stirring PAF-1 in each solvent overnight at ˜450 rpm. The solutions were then sonicated for 1 h before further sonicated using a probe sonicator for 1 min. The samples were then quickly transferred to a glass cuvette (PCS1115, Malvern), and DLS measurements were then performed at 25° C. We note that these dilute solutions were prepared such that each solution appeared optically transparent and nearly colorless to the naked eye, while still exhibiting the Tyndall effect The PAF-1 particles were assumed to have a refractive index of 2.0. The reported particle size distributions were compiled from at least three separate DLS measurements.

Field emission scanning electron microscopy (FESEM). FESEM images were taken using a Hitachi S-5000 SEM. Samples of bulk PAF-1 were prepared by first dispersing the materials in CH₂Cl₂ or H₂O by mixing overnight and then sonicating for 30 min. The dispersed PAF solutions were then drop casted onto silicon chips. The samples were sputter-coated with gold via a Tousimis sputter coater before imaging. Membrane film cross-section samples were prepared by fracturing the films in liquid nitrogen before sputter-coating with gold to dissipate charge.

Membrane glass transition temperature (T_{g}) measurements. Membrane glass transition temperature (T_{g}) values were determined via differential scanning calorimetry. A TA Instruments Q20 instrument was used. A scan rate of 10° C. min-1 under flowing helium was applied. The second heating scan was taken for the T_{g}.

Melting point measurements to assess water nanoconfinement in PAF pores. Differential scanning calorimetry using a TA Instruments Q20 instrument was used to measure the melting point of water filled in PAF pores. To prepare the sample, dried PAF-1 powder was added to an aluminum DSC pan until the pan was ˜75% filled. Water was then added dropwise until the PAF-1 sample appeared completely wetted, marked by a slight darkening of the PAF-1 sample color. The sample was left undisturbed and exposed to ambient air for 1 h to facilitate partial evaporation of bulk water between the PAF-1 particles. The pan was then sealed for DSC analysis.

A scan rate of 10° C. min⁻¹ from −80° C. to 60° C. was applied under flowing helium. Five temperature scans were recorded, and each scan displayed the same calorimetry profile. The experiments were repeated for a control sample of bulk water, by filling a DSC pan with water only. Ultrapure deionized water (18.2 MΩ cm electrical resistivity; <5.4 ppb total organic carbon) from a Millipore RiOs system was used as the water source for all experiments.

Nuclear magnetic resonance (NMR) spectroscopy to assess water nanoconfinement in PAF pores. Proton NMR spectra and relaxation measurements were used to further verify the ability of PAF-1 pores to accommodate bulk solvents such as water. Water was added dropwise to dried PAF-1 until the sample appeared completely wetted, marked by a slight darkening of the PAF-1 sample color. The sample was then packed into a 3.2-mm Bruker rotor and sealed. All ¹H solid-state NMR experiments were conducted at 9.4 T and a magic-angle spinning (MAS) rate of 20 kHz, using a Bruker NEO 400 MHz spectrometer with a Bruker 3.2 mm HX MAS probe. Proton spectra were acquired using the rotor-synchronized DEPTH sequence to remove background signal. A recycle delay of 5 s was used to ensure that quantitative data was obtained. Spin-lattice and spin-spin relaxation times were determined from saturation recovery and Hahn echo sequence with incremented delay times, respectively. Proton chemical shifts were externally referenced to adamantane at 1.8 ppm. The temperature was kept at approximately 35° C. during all measurements and externally calibrated using KBr. Acquisition, processing, and analysis was done using Topspin 2.1 or 3.6.3, and spectral convolution was done using dmfit.

The ¹H spectra can be deconvoluted into two separate Lorentzian peaks within the expected chemical shift range of water, suggesting two water species exist within the sample. The two features can be attributed to bulk water in between PAF particles and water within the pores of the framework. By taking advantage of this property, the identity of each peak was assigned based on respective relaxation times. This led to the assignment of 4.33 ppm as the in-pore water species and 4.26 ppm as bulk water.

Pure-gas permeation measurements. Single-component gas permeation experiments were completed to measure the performance of the composite and neat membranes. After membrane casting, approximately 0.5″ diameter samples were cut from the membrane films. The thickness of these film cuts were determined with a micrometer and measured 3-5 times to calculate the averaged final thickness. Afterwards, the films were epoxied (Loctite EA E-90FL) to brass shim discs with varied inner diameters to modify exposed film area. The exposed film areas were determined using a scanner. The epoxy was then allowed to cure at room temperature for a minimum of 24 hours before testing. For the composite membrane, the films were activated using a custom built heat mantle at 100° C. in situ under dynamic vacuum in the permeation system for 24 hours prior to measurement. The permeation system was filled with water and heated to 35° C. The gas leak rate was measured under static vacuum prior to system pressurization and was then subsequently subtracted from the permeation rates at each upstream pressure. The leak rate was <1% of all the permeation rates measured. When collecting permeation measurements on a sample, the gas order performed was N₂, CH₄, O₂, He, H₂, CO₂, C₂H₆, and C₂H₄. This procedure allowed for avoiding the propagation of error from the membrane thickness and exposed area when calculating the ideal selectivities of the films. Steady-state permeation rates were measured by running the measurement to be at least six times the time lag. The time lag is defined as the intercept on the time-axis on the pressure vs. time plot and is determined by fitting the linear region. Equation S1 was utilized to calculate the pressure-based permeability, where P is the permeability, 1 is the thickness of the film, V_{cell} is the volume downstream of the membrane, A is the exposed area of the membrane, P_{f} is the upstream pressure, R is the gas constant, T is the temperature in K,

$${( \frac{dP}{dt} )}_{ss}$$

is the steady-state permeation rate, and

$${( \frac{dP}{dt} )}_{leak}$$

is the leak rate. The unit of permeability is the Barrer

$$( 1 Barrer = {10}^{- 10} \frac{{cm}^{3} ( STP ) \cdot cm}{{cm}^{2} \cdot s \cdot cm Hg} ) . \qquad ( S1 )$$

$$P = \frac{l \cdot {V}_{cell}}{A \cdot {P}_{f} \cdot R \cdot T} [ {( \frac{dP}{dt} )}_{ss} - {( \frac{dP}{dt} )}_{leak} ]$$

Mixed-gas permeability measurements were completed utilizing a Maxwell Robotics constant-volume/variable-pressure system connected to a Scion 456-GC to analyze CO₂ and N₂ mixed-gas permeabilities. Similar samples on disc supports to the single-component gas measurements were fabricated and inserted into a stainless steel permeation cell. The sample was activated at 100° C. in situ under dynamic vacuum in the permeation system for 24 hours prior to measurement.

Mixed-gas permeation measurements. A custom gas manifold with two mass flow controllers was connected to a Maxwell Robotics mixed gas permeation system and Scion 456 gas chromatograph (GC).

The system was calibrated for measurements of CO₂/N₂ mixtures. During calibration, the permeation system was dosed with carbon dioxide mixtures ranging from 50% to 99% in nitrogen before the gas was sampled into the gas chromatograph for measurement. Expected carbon dioxide values were determined from the calibrated mass flow controllers and then plotted and compared to the experimentally measured carbon dioxide contents.

After finalizing the mixed gas permeation calibration, neat 6FDA-DAM, 10 wt % PAF-1 in 6FDA-DAM, and 20 wt % PAF-1 in 6FDA-DAM membranes were tested using a 50:50 CO₂/N₂ feed mixture. These measurements were performed at 35° C. and using 1-4 atm feed pressures.

Gas sorption isotherms. Gas adsorption experiments for CO₂, O₂, N₂, CH₄, and H₂ were conducted on a Micromeritics ASAP 3-Flex instrument between 0-1.0 bar. Isotherms were measured at 35° C. using a temperature-controlled water bath. The samples were activated at 120° C. for 18 hours prior to gas adsorption measurements. Adsorption isotherms were run in order of least polarizing to most polarizing, or in the order of H₂, O₂, N₂, CH₄, and CO₂. The samples were re-activated between isotherms under vacuum for at least 4 h.

) The solubility (S, cm³(STP) cm⁻³ bar⁻¹) of each membrane was then calculated according to the following equation, based on the membrane density (ρ, g cm⁻³, determined from helium pycnometry) and quantity of gas adsorbed (n₀, cm³(STP) g⁻¹) at the feed pressure, p₀ (1 bar):

$$S = \frac{ρ {n}_{0}}{{p}_{0}} \qquad ( S2 )$$

The diffusivity (D, cm² s⁻¹) of each membrane was then calculated according to the solution-diffusion model, based on the measured permeability (P) and solubility (S) of each membrane:

$$D = \frac{P}{S} \qquad ( S3 )$$

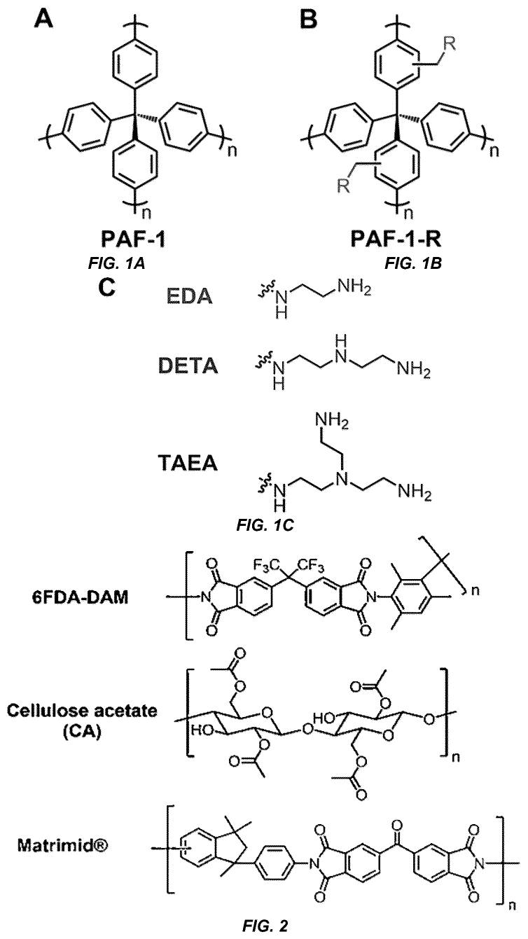

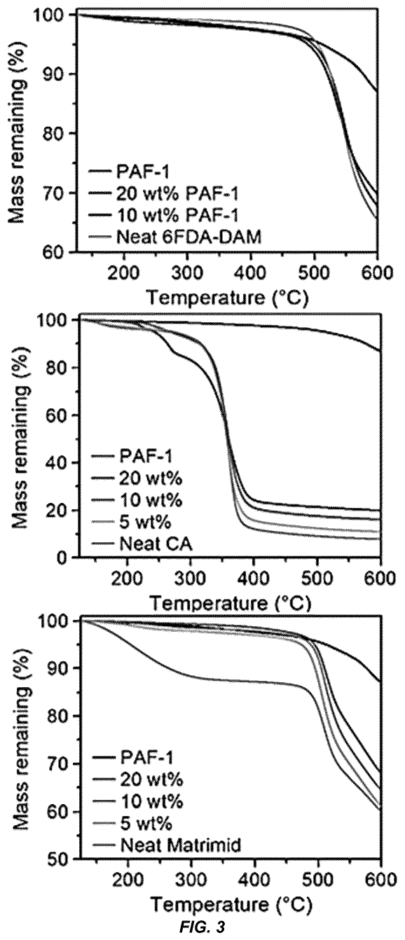

Each of the PAF-1 particles (FIG. 1A) and membrane polymers (FIG. 2) were synthesized or obtained using methods described previously. Composite membranes were fabricated with up to 20 wt % PAF-1 (FIG. 1A) in 6FDA-DAM (6FDA=4,4′-(hexafluoroisopropylidene)diphthalic anhydride; DAM=2,4,6-trimethyl-1,3-phenylenediamine, FIG. 2), a polymer known to exhibit excellent selectivity and permeability properties that place it near the theoretical upper bounds for pure polymer membranes for a variety of gas pairs. Helium pycnometry and nitrogen gas sorption measurements show that the volume percentage of PAF-1 in the 20 wt % PAF-1 in 6FDA-DAM membranes is approximately 50 vol % (Table 1). This high volume-based loading results from the low measured density (0.33 g/mL) of the highly porous PAF-1 particles (Brunauer-Emmett-Teller surface area: 4520 m²/g). The measured density notably agrees closely with predicted densities (0.315-0.34 g/mL) for models of the expected dia structures proposed for the amorphous PAF-1. Due to the higher thermal stability of the PAF-1 particles (decomposition temperature >500° C.), high thermal stability is also maintained in the composite membranes (FIG. 3).

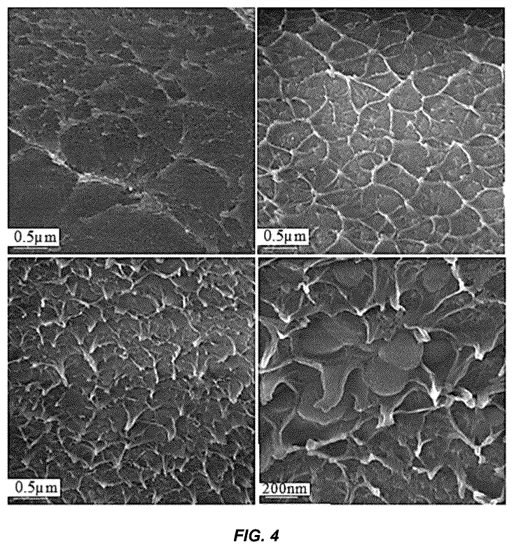

Various characterizations indicate that the PAF-1 particles are highly dispersed and highly compatible with the 6FDA-DAM polymer membrane. Cross-sectional scanning electron microscopy (SEM) images of neat, 10 wt %, and 20 wt % PAF-1 in 6FDA-DAM membranes displayed high volume-based loadings of PAF-1 (FIG. 4). These imaged PAF-1 particles typically exhibit particle size diameters between 100-200 nm. Importantly, zoomed-in SEM images revealed strong interactions at the interface between the PAF particles and membrane polymer matrix without apparent defects, agglomerations, or sieve-in-a-cage morphologies (FIG. 4). This high PAF/polymer compatibility was also corroborated by increases in glass transition temperature (T_{g}) observed in the membranes upon increases in PAF-1 loadings (Table 2). The high uniformity and compatibility of the PAF composite membranes is attributed to favorable π-π stacking, van der Waals interactions, and PAF mesopore filling between the framework and polymer membrane. The formation of defect-free interfaces—imperative for high-selectivity gas transport—were further promoted by a “priming” step used in the membrane fabrication process. Here, prior to each membrane casting, ˜30% of the polymer solution was first added to a solution of dispersed PAF particles before further stirring, sonicating, and adding the remaining polymer solution. This priming step is used to coat the PAFs with a thin polymer layer before dispersing with the rest of the polymer solution, improving the interactions and homogeneity between the PAFs and polymer matrix.

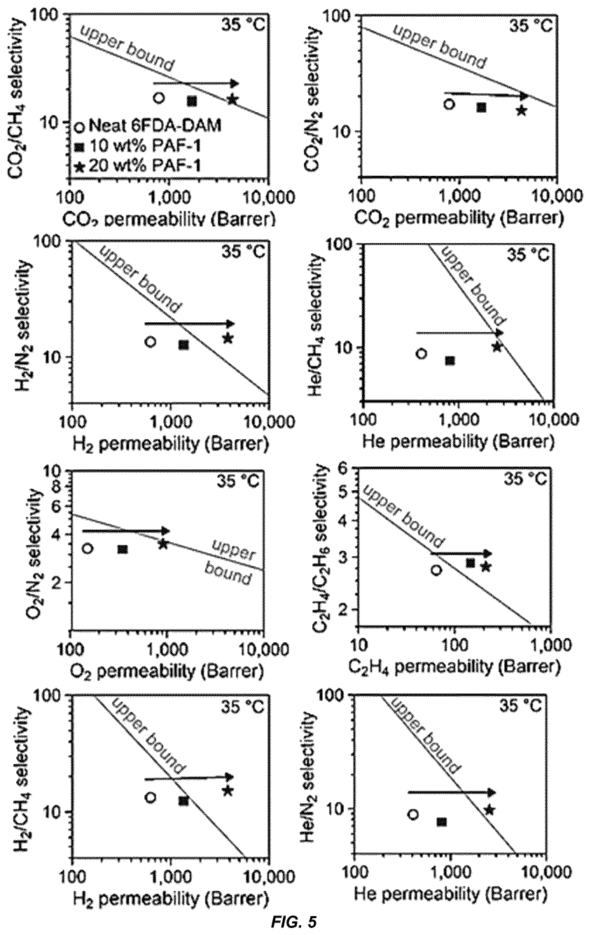

Experiments were then performed to investigate the gas transport properties of H₂, He, CH₄, N₂, O₂, and CO₂ through the neat and composite membranes, using single-component permeation measurements. These six gases were chosen for their high ubiquity in industrial gas separations and diversity in chemical properties, kinetic diameters, and condensabilities (Table 3). It was postulated that permeability increases should arise in the composite membranes due to the ultrahigh porosities of the PAF-1 fillers, which should provide non-selective but high-diffusivity gas transport pathways that are not offered in conventional neat polymer membranes such as 6FDA-DAM. Remarkably, the permeation measurements revealed that the permeabilities of all six gases increase by ˜500% upon loading the neat 6FDA-DAM membranes with just 20 wt % PAF-1 (FIG. 5).

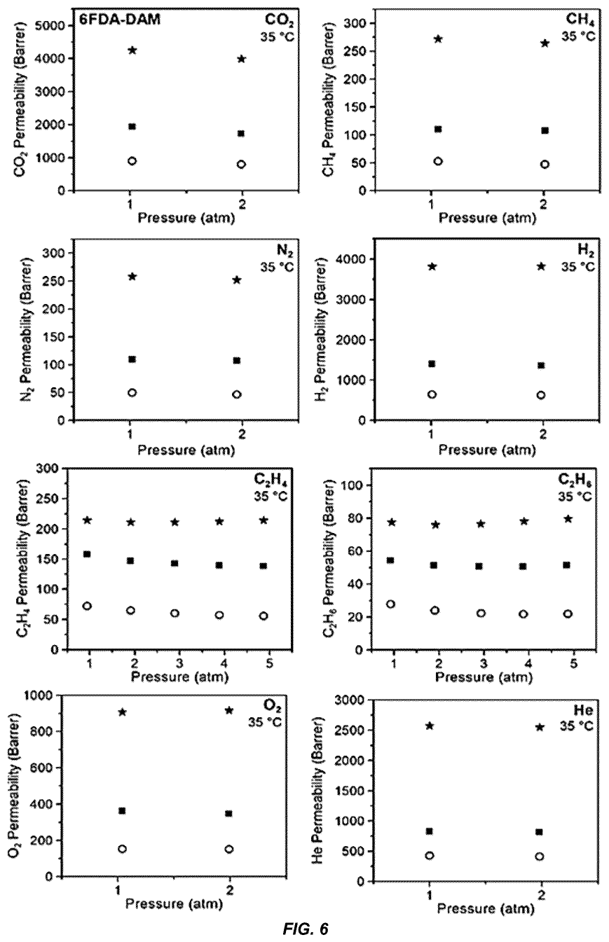

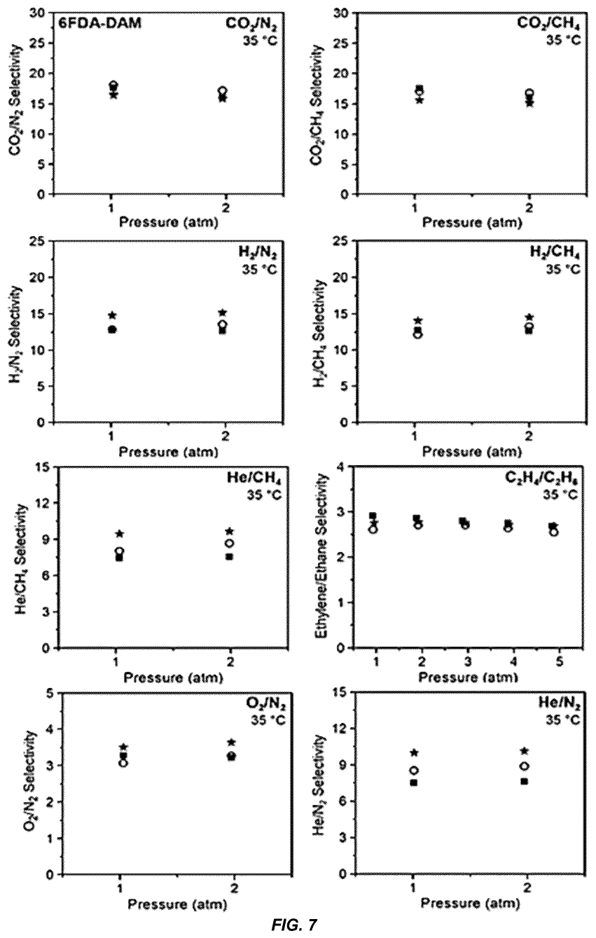

The gas permeation selectivity between two gases can be computed as the ratio of the permeabilities of each gas. In this manner, the gas permeation selectivities of the neat and composite membranes were extracted for seven gas pairs highly targeted in industrial gas separations (CO₂/CH₄, in natural gas processing; CO₂/N₂, in power plant flue gas; H₂/CH₄, in off-gas processing in refineries; H₂/N₂, in ammonia synthesis purge gas; He/CH₄, in natural gas reserves; He/N₂, in off-gas from the nitrogen rejection unit in natural gas processing plants; O₂/N₂; in air separations). The measured permeabilities and selectivities of the fabricated membranes for each gas pair are plotted in FIG. 5, along with the predicted upper bound performances established for pure polymer membranes. A clear trend was observed in each of these seven selectivity versus permeability plots upon increased PAF-1 loading: a favorable horizontal shift to the right approaching or surpassing the upper bounds. These shifts—generalizable to every gas pair—correspond to elevated permeability (from the highly porous PAF-1 fillers) but retained selectivity (from the selective polymer matrix). These dual-transport mechanisms and retained selectivities are enabled by the priming step used in membrane fabrication, which helps prevent non-selective percolation networks, PAF-1 agglomerations, and interfacial defects in the membranes. In addition the membranes were tested for the separation of ethylene and ethane, as olefin/paraffin separations remain among the most challenging yet sought-after membrane separations. In these permeation tests, the 10 and 20 wt % PAF-1 membranes exhibited performances that surpassed the upper bound while following the same trends previously described. The membrane performances for all gases also remained approximately constant at all pressures tested (FIGS. 6 and 7).

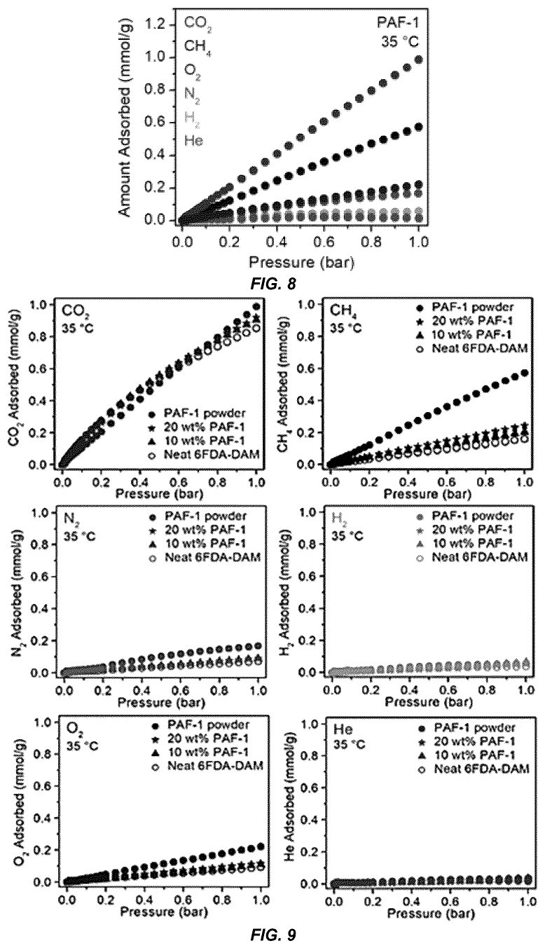

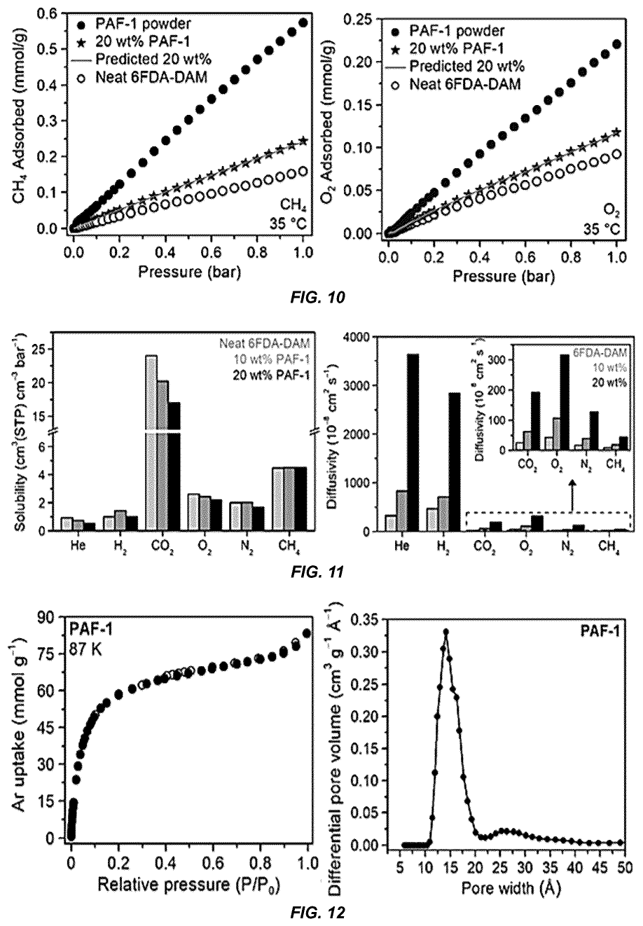

To better elucidate the gas transport mechanisms of the composite membranes, gas adsorption isotherms data was collected for the membranes and bulk PAF-1 material (FIGS. 8 and 9). To this end, solubilities were calculated based on the membrane densities (Table 1) and quantities of gas adsorbed at 1 bar. The solution-diffusion model was then applied to determine diffusivities, which were calculated as the ratio of the measured gas permeability to solubility. Bulk PAF-1 exhibited linear adsorption profiles for all six gases, suggesting physisorptive adsorption with low affinity for any particular gas. These non-selective gas interactions are particularly advantageous for using PAF-1 as a generalizable filler that allows gas permeability increases without compromising membrane selectivity for any gas. For every gas analyzed, the gas solubility remained relatively constant in the membranes regardless of PAF-1 loading, while the diffusivity of every gas dramatically increased upon increased PAF-1 loading (FIG. 11). These trends confirm that the heightened gas permeabilities in the PAF composite membranes are enabled by enhanced gas diffusive transport through the accessible PAF-1 pores. These static PAF pores, which are large enough (˜1.5 nm diameter, FIG. 12) to easily accommodate gas molecules, provide transport pathways in the membranes for rapid gas Knudsen diffusion. Importantly, the gas adsorption isotherms also revealed that approximately all PAFs embedded in the membranes remain accessible to gas transport, as the measured gas uptake by the composite membranes matched those expected from the weighted-average uptake between the neat 6FDA-DAM membrane and bulk PAF-1 (FIG. 10).

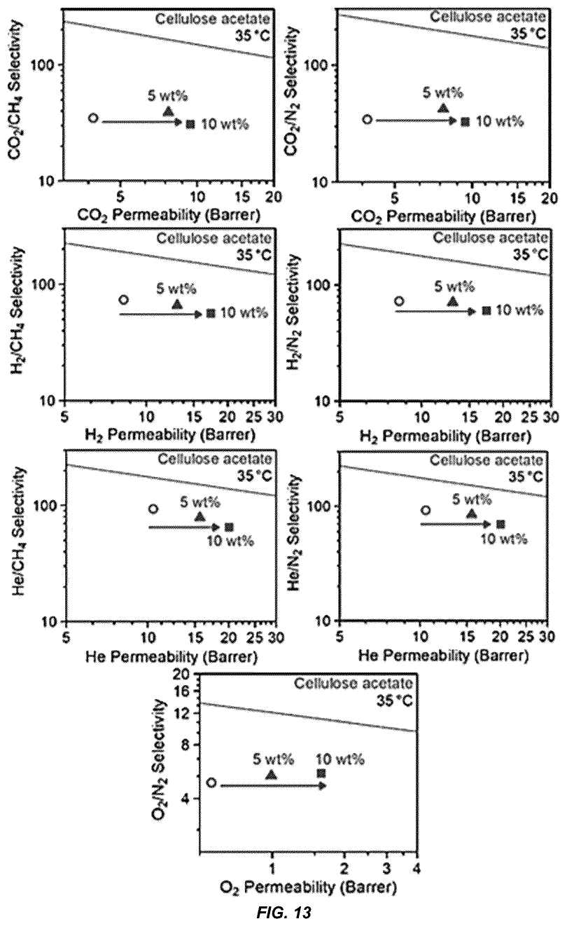

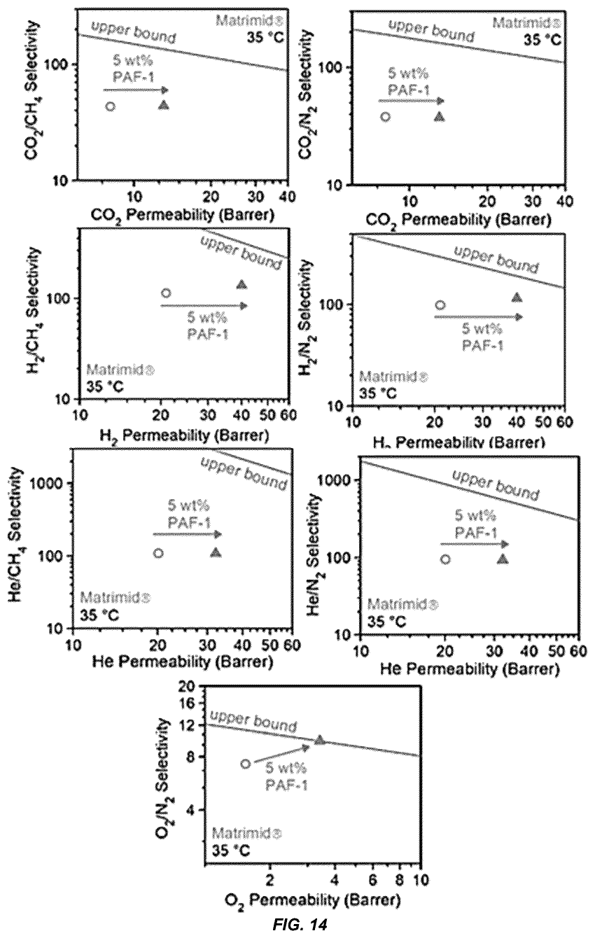

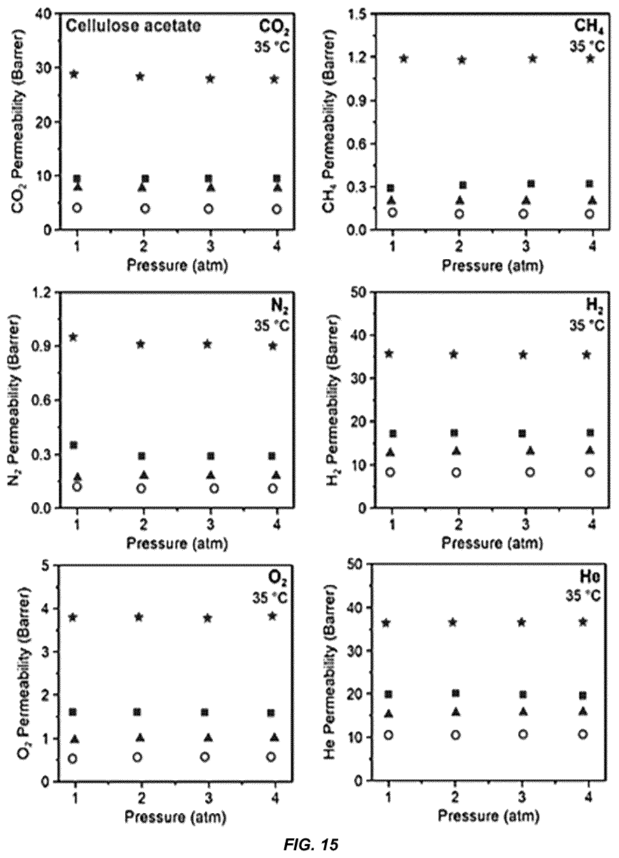

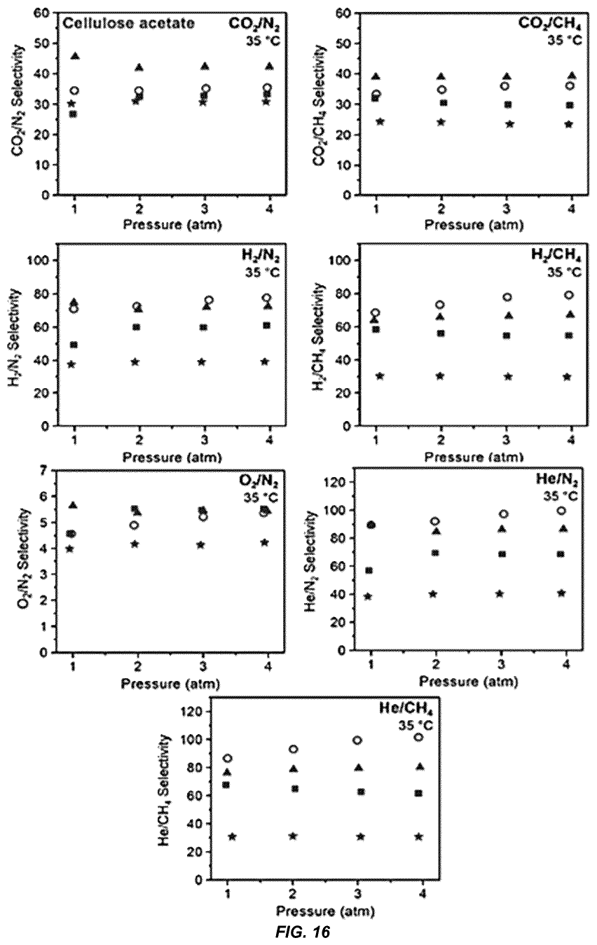

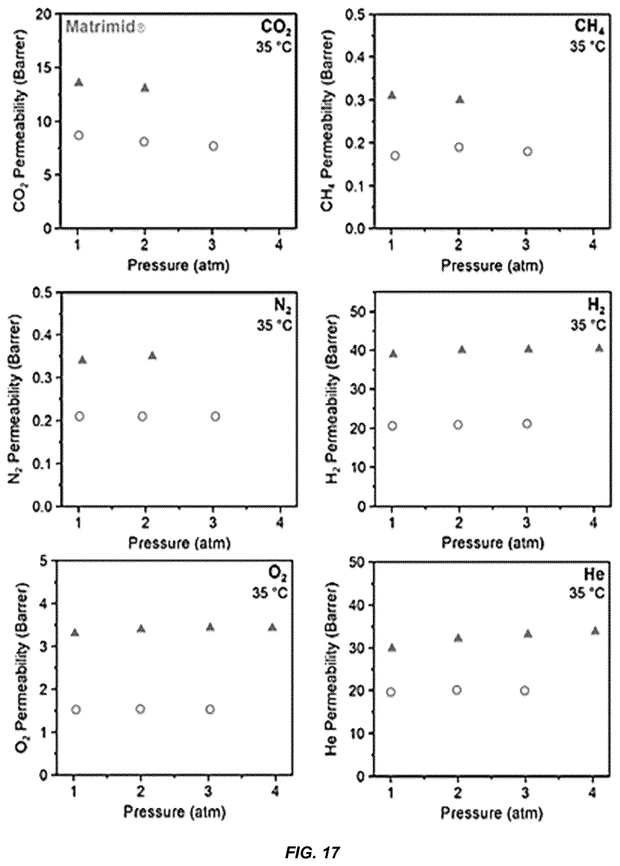

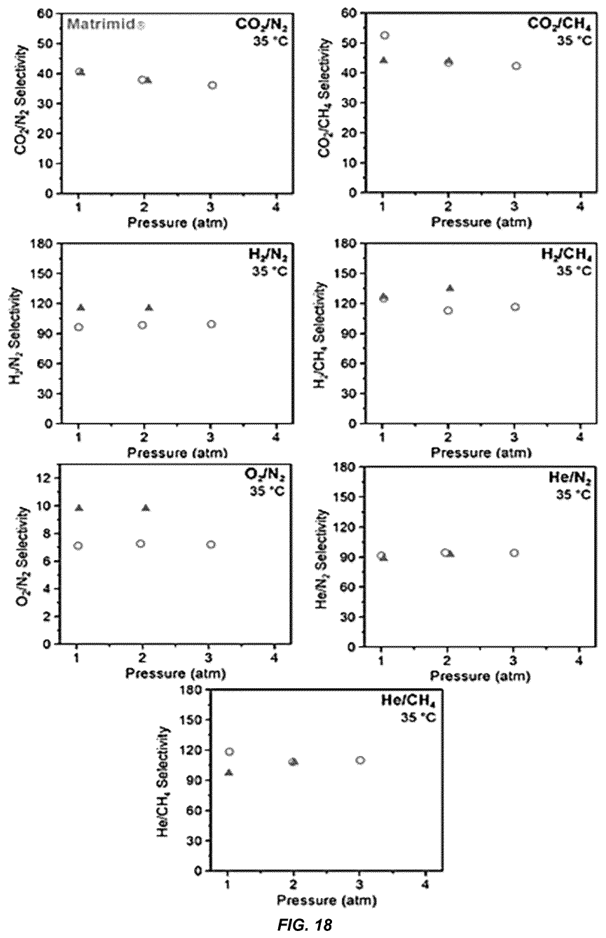

To assess the generalizability of this PAF-1 approach for increasing permeability while retaining selectivity in a wider variety of dense membrane polymers, PAF-1 composite membranes were also synthesized using Matrimid® 5218 or cellulose acetate as the polymer matrix (FIG. 2). These polymers were chosen due to their diversity in chemical structures (e.g., cellulose acetate does not contain aromatic groups), higher selectivities for various gas pairs relative to 6FDA-DAM, and high use in industrial membrane separations. Composite PAF-1 membranes based on both of these polymers exhibited the same favorable trends as those observed for the 6FDA-DAM membranes: dramatic increases in permeability for all six gases tested (e.g., nearly doubled upon just 5 wt % PAF-1 loading), yet approximately constant selectivity for all seven relevant gas pairs analyzed (FIGS. 13 and 14). These performances also remained consistent at all feed pressures tested (FIGS. 15-18). However, it is noted that cellulose acetate membranes prepared with 20 wt % PAF-1 exhibited decreased selectivity for every gas pair, along with a jump in the permeability of each gas. This behavior indicates the formation of PAF-1 percolation networks that span across these densely loaded membranes.

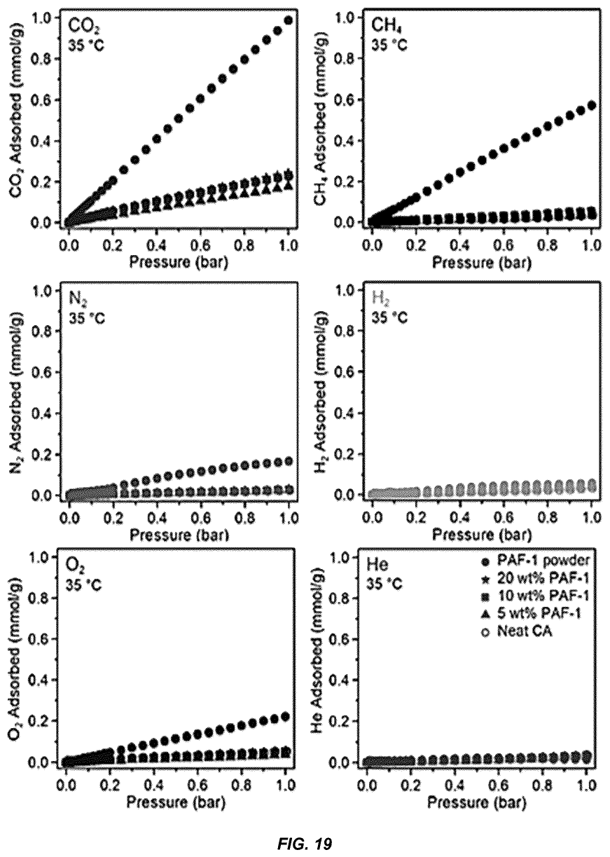

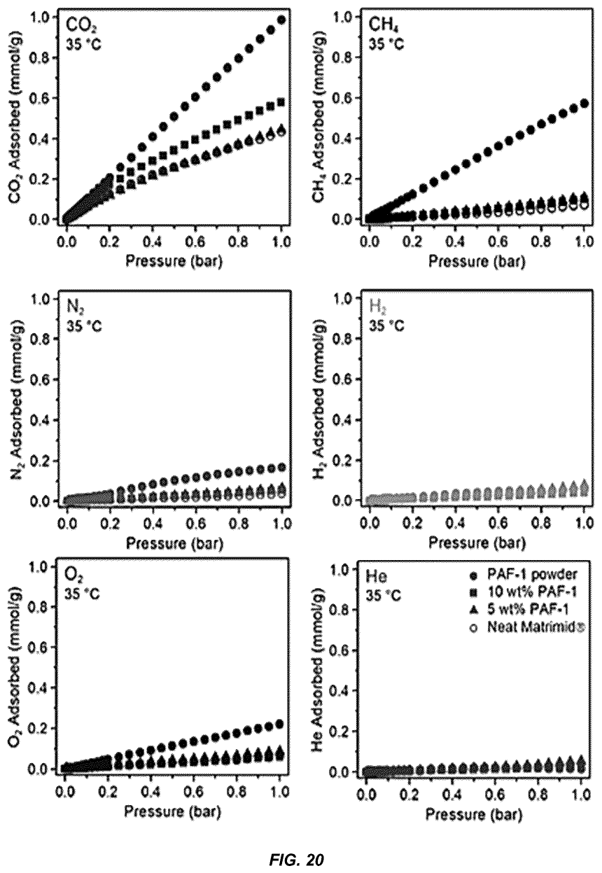

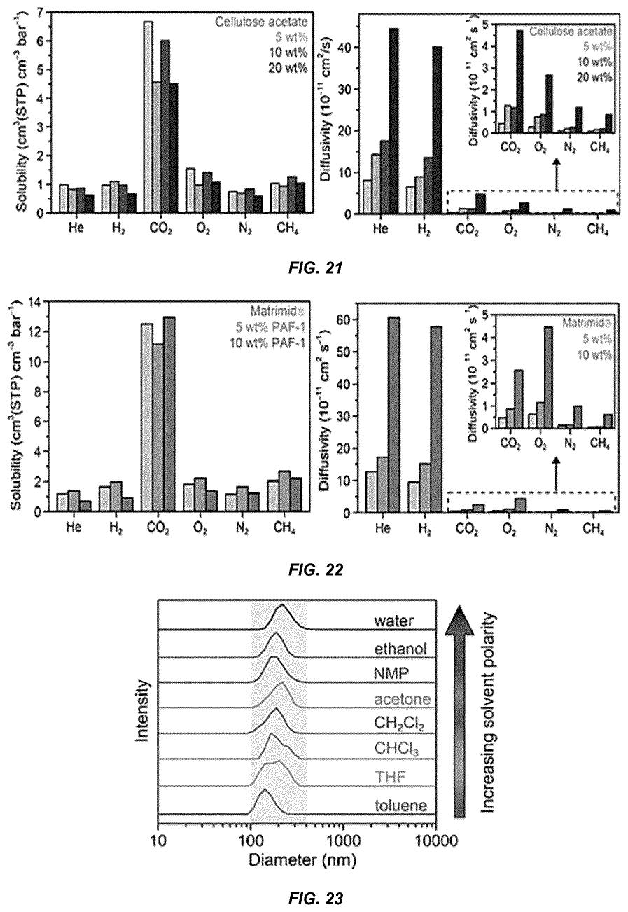

To confirm that these gas separation performance enhancements in Matrimid® and cellulose acetate arise from high-diffusivity transport pathways supplied by the embedded PAF-1 particles, gas adsorption isotherms were collected for all six tested gases, for each tested membrane (FIGS. 19 and 20). Solubility and diffusivity analyses using the solution-diffusion model confirmed these gas transport mechanisms (FIGS. 21 and 22). Indeed, the solubility of each gas remained approximately constant regardless of PAF-1 loading in the membranes. However, the diffusivity of each gas dramatically increased upon increasing PAF-1 loading, with relative diffusivity increases mirroring the relative permeability increases observed in the membranes with heightened PAF-1 loading.

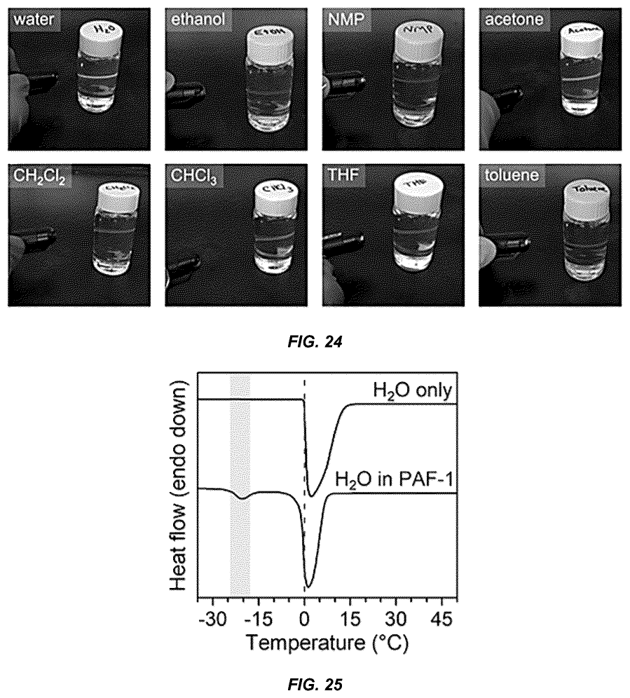

While 6FDA-DAM, Matrimid®, and cellulose acetate were used as model gas separation membrane polymers for the PAF-1 enhancement approach, the disclosure also shows for the first time that these PAFs can be successfully dispersed in virtually any common membrane casting solvent. This versatile and robust property allows PAFs to be potentially applied to an even larger selection of dense membrane materials, which often require varied solvent choices according to polymer solubility, casting process, and desired film property. Dynamic light scattering measurements were performed to assess the dispersibility of PAF-1 in eight common solvents (toluene, tetrahydrofuran, chloroform, dichloromethane, acetone, N-methyl-2-pyrrolidone, ethanol, and water). These diverse solvents range substantially in boiling point, polarity, and dielectric constant (Table 4). Dynamic light scattering measurements (FIG. 23) and Tyndall scattering (FIG. 24) revealed that PAF-1 remains dispersed in each solvent as 100-200-nm particles following the mixing and sonication steps used for membrane fabrication. Additionally, no PAF-1 agglomerations were observed in any of the particle size distributions.

This generalizable dispersibility can be attributed to the ability of the PAF-1 pores to be filled with solvent molecules, facilitating dispersion through attractive interactions between bulk solvent and pore-filled solvent. Indeed, dynamic scanning calorimetry experiments revealed that PAF-1 samples soaked with water exhibit a melting point peak around −24° C., consistent with melting point depressions observed for water nanoconfined in other materials with pore sizes similar to those of PAF-1 (FIG. 25). This pore filling property interestingly occurs due to the highly porous nature of PAF-1 despite its high hydrophobicity.

Membrane plasticization remains a major obstacle to the commercialization of gas separation membrane technologies in industry, especially for natural gas purification. Plasticization from CO₂ in natural gas at high feed pressures leads to membrane polymer swelling, resulting also in worsened CO₂ permeation selectivity (due to increased non-selective permeation of undesired gases) and potential mechanical failure. To address these issues using 6FDA-DAM as a model membrane polymer, particles of PAF-1 functionalized with polyamines were embedded (FIGS. 1B and 1C) into this membrane polymer. The grafted polyamine groups allow hydrogen-bonding interactions with the imide groups on the polyimide polymer. These interactions act as stabilizing crosslinkers to reduce membrane swelling and thus plasticization effects.

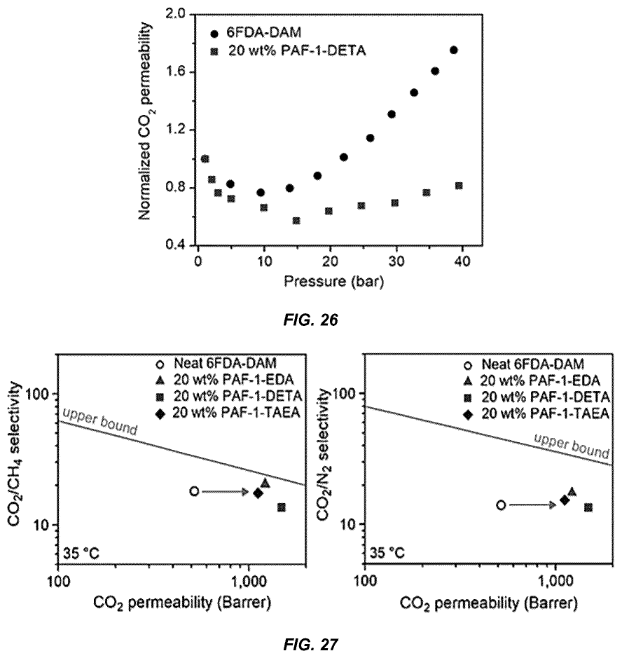

To test these plasticization resistance enhancements, CO₂ permeation measurements were performed at increasing pressures up to 40 bar, for both neat 6FDA-DAM membranes and 20 wt % PAF-1-DETA (DETA=diethylenetriamine) in 6FDA-DAM membrane (FIG. 26). The 6FDA-DAM membranes exhibited a 10-bar plasticization pressure, defined as the pressure after which the normalized CO₂ permeability begins to increase due to membrane swelling. Conversely, the 20 wt % PAF-1-DETA membranes advantageously exhibited a plasticization pressure ˜1.5 times higher. The improved membrane swelling resistance enabled by PAFs grafted with hydrogen-bonding polyamines was further confirmed through membrane dissolution tests. Here, casted membranes were fully immersed in the casting solvent (chloroform) for over one month. While the neat 6FDA-DAM membranes immediately dissolved in the solvent as expected, 20 wt % PAF-1-R (R=EDA, DETA, or TAEA; FIG. 1C) in 6FDA-DAM membranes remained as insoluble films due to the presence of the stabilizing, swelling-resistant hydrogen bonding interactions between the PAFs and membrane polymer. Finally, permeation measurements also revealed that membranes incorporated with polyamine-grafted PAF-1 achieve the same trends as those previously described for PAF-1 membranes (FIG. 27). Here, 20 wt % PAF-1-R (R=EDA, DETA, or TAEA) in 6FDA-DAM membranes exhibited gas permeabilities that were 2-3 times higher than those for neat 6FDA-DAM membranes, while CO₂/N₂ and CO₂/CH₄ selectivities remained approximately constant. These results show the high promise for using PAFs grafted with hydrogen-bonding moieties to enhance plasticization resistance and permeabilities without compromising gas selectivity.

TABLE 1
Comparison of PAF-1 weight-based loadings
to volume-based loadings.

| Membrane | PAF-1 loading | PAF-1 loading |
|---|---|---|
| polymer | (wt %) ^{a} | (vol %) ^{b} |
| 6FDA-DAM³¹ | 10 | 29.6 |
| | 20 | 48.6 |
| Cellulose acetate | 5 | 17.3 |
| | 10 | 30.6 |
| | 20 | 49.8 |
| Matrimid ® | 5 | 16.8 |
| | 10 | 29.9 |

^{a} Theoretical PAF-1 weight-based loadings are based on the relative masses of PAF-1 used compared to membrane polymer during membrane fabrication.
^{b} Volume-based PAF-1 loadings were calculated from helium pycnometry (measured PAF-1 density: 0.33 g/mL; measured cellulose acetate density: 1.32 g/mL; measured Matrimid ® density: 1.28 g/mL; 6FDA-DAM polymer density was taken from literature), the amount of N₂ gas adsorption uptake at P/P₀ = 0.98, and the theoretical wt % loadings.

TABLE 2
The glass transition temperature (T_{g}) for composite membranes
consisting of PAF-1 loaded into different polymer membranes,
with increased T_{g} indicating favorable interactions between the
PAFs and polymer matrix. T_{g} values were measured using dynamic
scanning calorimetry at a ramp rate of 10° C. min⁻¹ under
flowing helium.

| Membrane | PAF-1 loading | T_{g} |
|---|---|---|
| polymer | (wt %) | (° C.) |
| 6FDA-DAM | 0 | 388 |
| | 10 | 391 |
| | 20 | 392 |
| Matrimid ® | 0 | 322 |
| | 5 | 323 |
| | 10 | 324 |

TABLE 3
Physical properties of the gases studied in this work. Gases
are listed in order of lowest to highest molecular weight.

| | | | | | Quadrupole |
|---|---|---|---|---|---|
| | Molecular | Boiling | Kinetic | Polarizability | moment |
| | weight | point | diameter | ×10²⁵ | ×10²⁶ |
| Gas | (g/mol) | (K) | (Å) | (cm³) | (esu cm²) |
| H₂ | 2.0 | 20.4 | 2.89 | 8.04 | 0.66 |
| He | 4.0 | 4.2 | 2.60 | 2.05 | 0 |
| CH₄ | 16.0 | 111.6 | 3.80 | 25.93 | 0 |
| N₂ | 28.0 | 77.3 | 3.64 | 17.40 | 1.52 |
| C₂H₄ | 28.1 | 169.5 | 4.16 | 42.52 | 1.50 |
| C₂H₆ | 30.1 | 184.6 | 4.44 | 44.50 | 0.65 |
| O₂ | 32.0 | 90.2 | 3.46 | 15.81 | 0.39 |
| CO₂ | 44.0 | 194.7 | 3.30 | 29.11 | 4.30 |

TABLE 4
Properties of solvents studied in dispersed PAF-1 DLS particle size distribution
measurements. Solvents are listed in order of lowest to highest boiling point.

| | Boiling point | Normalized relative | Dielectric |
|---|---|---|---|
| Solvent | (° C.) | polarity value | constant (F/m) |
| Dichloromethane | 40 | 0.309 | 8.9 |
| Acetone | 56 | 0.355 | 20.7 |
| Chloroform | 61 | 0.259 | 4.8 |
| Tetrahydrofuran (THF) | 66 | 0.207 | 7.6 |
| Ethanol | 78 | 0.654 | 24.6 |
| Water | 100 | 1.000 | 80.1 |
| Toluene | 111 | 0.099 | 2.4 |
| N-methyl-2-pyrrolidone (NMP) | 202 | 0.355 | 32.2 |

It will be understood that various modifications may be made without departing from the spirit and scope of this disclosure. Accordingly, other embodiments are within the scope of the following claims.

1. A composite membrane comprising a polymer/membrane matrix that contains or is embedded with one or more types of porous aromatic frameworks (PAFs), porous organic frameworks (POFs) and/or porous polymer networks (PPNs), wherein the one or more types of PAFs, optionally comprising functional groups, bind with a high specificity to a targeted ion, organic molecule, or contaminant, wherein the one or more types of PAFs comprise a series of nodes linked together by linking ligands, wherein the series of nodes have a formula of Formula Ia: 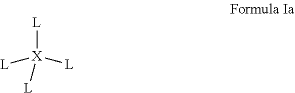
wherein, X is selected from C, B⁻ and P⁺; or
wherein the series of nodes have a formula of Formula Ib: 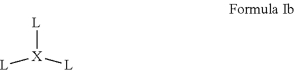
wherein, X is selected from N, Si, Ge, a benzene and Al,
and L is a linking ligand; and wherein the linking ligand has a structure of Formula II or III: 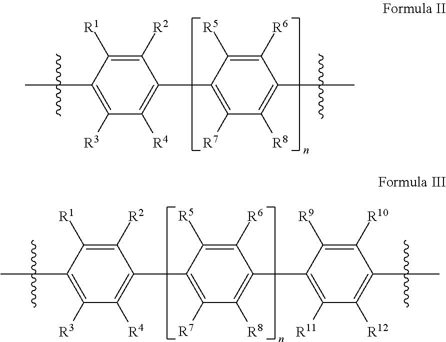
wherein, R¹-R¹² are independently selected from H, C₁₋₅ alkane or a polyamine; and n is an integer selected from 0, 1, 2, 3, 4, or 5; and
wherein the composite membrane maintains selectivity to a targeted organic molecule, contaminant, or other gas in the presence of other competing molecules when compared to the pure polymer membrane material absent the one or more PAFs, POFs and/or PPNs.

2. The composite membrane of claim 1, wherein the PAF, has the general structure: 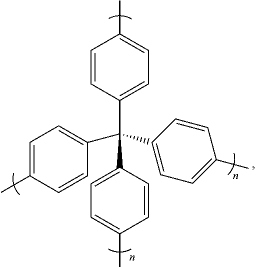
wherein n is any integer between 2 and 500.

3. The composite membrane of claim 1, wherein the PAF, has the general structure: 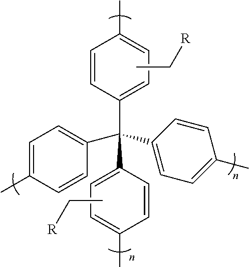
wherein R is a C₁₋₅ alkane or a polyamine
wherein n is any integer between 2 and 500.

4-5. (canceled)

6. The composite membrane of claim 1, wherein the polymer/membrane matrix is selected from the group consisting of polyolefins; polystyrene; silicones; polyacetylenes; polysulfones; polysulfonamides; polyacetals; polyethers; polyethylenimines; polycarbonates; cellulosic polymers; polyamides; polyimides; polyetherimides; polyamide imides; polyketones; polyether ketones; polyarylene oxides; polyurethanes; polyureas; polyazomethines; polyesters; polysulfides; heterocyclic thermoplastics; polycarbodiimides; polyphosphazines; polyhydrazides; and copolymers thereof, including block copolymers, grafts, and blends thereof.

7. The composite membrane of claim 6, wherein the polymer/membrane matrix is selected from the group consisting of cellulose acetate, polysulfones, perfluoropolymers, polyphenylene oxide, polyamides, polyimides, aryl polyetherimides, polyetherimides, Ultem 1000, (4,4′-hexafluoroisopropylidene)diphthalic anhydride (6FDA)-based polyimides, 6FDA-DAM, 6FDA-DAT, 6FDA-Durene, 6FDA-DAT:DAT, and Matrimid 5218.

8. The composite membrane of claim 1, wherein the PAFs, POFs, and/or PPNs are present at a density of about 0.315-0.345 g/mL.

9. The composite membrane of claim 1, wherein the PAFs, POFs, and/or PPNs are present at about 5-40 wt % of the composite membrane.

10. The composite membrane of claim 1, wherein the PAFs, POFs, and/or PPNs are present at about 10-55 vol % in the polymer/membrane matrix.

11. The composite membrane of claim 1, wherein the composite has a glass transition temperature of about 390-395° C. in a membrane matrix of 6FDA-DAM.

12. The composite membrane of claim 1, wherein the PAFs, POFs and/or PPNs comprise a substantially uniform pore size.

13. The composite membrane of claim 1, wherein the PAFs, POFs and/or PPNs are substantially evenly distributed in the polymer/membrane matrix.

14. The composite membrane of claim 1, wherein the PAFs, POFs and/or PPNs comprise a particle size of 50-300 nm.

15. The composite membrane of claim 1, wherein the PAFs, POFs and/or PPNs form (i) a π-π stacking between aromatic groups on the PAFs, POFs and/or PPNs and polymer/membrane matrix aromatic groups; and/or (ii) hydrogen bonds between amines or oxygen-rich groups appended onto PAFs, POFs, and/or PPNs and polar moieties on polymer/membrane matrix groups.

16. (canceled)

17. The composite membrane of claim 15, wherein the presence of the PAFs, POFs, and/or PPNs in the polymer/membrane matrix improves the mechanical property of the membrane compared to membranes lacking the PAFs, POFs, and/or PPNs.

18-19. (canceled)

20. The composite membrane of claim 1, wherein the composite comprises increased permeation rates compared to polymer/membrane composites lacking PAFs, POFs and/or PPNs with minimal to no decreases in selectivity.

21. A method of making a composite membrane of claim 1, the method comprising:
(a) adding about 30% of the polymer/membrane matrix to a solution of dispersed PAFs, POFs and/or PPNs particles and allowing the polymer membrane matrix material to coat the PAFs, POFs and/or PPNs; and
(b) adding the remaining polymer/membrane matrix material to (a).

22. A method for removing a targeted contaminant from a fluid feedstock:
contacting a fluid feedstock with a composite membrane of claim 1, wherein the fluid feedstock comprises the targeted contaminant,
wherein the targeted contaminant is absorbed, captured or selectively allowed to pass through the membrane by the PAFs, POFs and/or PPNs present in the composite membrane.

23. The method of claim 22, wherein the fluid feedstock comprises a targeted contaminant selected from carbon dioxide, hydrogen sulfide, nitrogen, water, sulfur oxide, nitrogen oxide, olefin, paraffin, helium, hydrogen, oxygen and methane.

24. (canceled)

25. The method of claim 23, wherein the method is used in coal flue gas, oxy-fuel combustion, air, biogas, and natural gas.

26. The method of claim 22, wherein the method separates H₂ in syngas, ammonia synthesis purge gas, and refinery fuel gas streams.

27. The method of claim 22, wherein the method is used to separate helium in natural gas and off gas from nitrogen rejection units used in natural gas processing.

28. The method of claim 22, wherein the method is used for recovery of oxygen found in ambient air.
